(19) United States
(12) Patent Application Publication
(10) Pub. No.: US 2026/0036440 A1
(43) Pub. Date: Feb. 5, 2026

(54) INDUCTIVE ANGULAR-POSITION SENSING OVER MULTIPLE MEASUREMENT RANGES USING A SINGLE TARGET, INCLUDING RELATED APPARATUSES AND METHODS

(71) Applicant: Microchip Technology Incorporated, Chandler, AZ (US)

(72) Inventors: Ganesh Shaga, Warangal (IN); Surendra Akkina, Hyderabad (IN); Sudheer Puttapudi, Hyderabad (IN)

(21) Appl. No.: 19/208,406

(22) Filed: May 14, 2025

(30) Foreign Application Priority Data
Jul. 31, 2024 (IN) 202441057901

(51) Int. Cl. G01D 5/20; G01D 5/245

(52) U.S. Cl. CPC G01D 5/2053; G01D 5/2454; G01D 2205/26

(57) ABSTRACT

An apparatus comprises a support structure, a first set of coils, a second set of coils, and a target. The first and the second set of coils are on, or in, the support structure and arranged within an annulus centered about an axis. The first set of coils include first and second sense coils, where respective ones of the first and the second sense coils have one or more M pole pairs. The second set of coils include third and fourth sense coils, where respective ones of the third and the fourth sense coils have N pole pairs. The target is to rotate about the axis. The target includes a target body comprising an annular ring and one or more fin regions. Respective fin regions of the one or more fin regions include a number of fins radially extending outwardly from the annular ring.

### PRIORITY CLAIM

This application claims the benefit of the filing date of Republic of India Provisional Patent Application No. 202441057901, filed Jul. 31, 2024, for “Inductive Angular-Position Sensing Over Multiple Measurement Ranges Using A Single Target, Including Related Apparatuses And Methods,” the disclosure of which is hereby incorporated herein in its entirety by this reference.

### FIELD

This disclosure relates generally to inductive angular-position sensing. More specifically, some examples relate to inductive angular-position sensing for measuring the angular-position of a movable target, without limitation. Additionally, related apparatuses and methods are disclosed.

### BACKGROUND

If a coil of wire is placed in a changing magnetic field, a voltage will be induced at ends of coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a disturber of a predictably changing magnetic field based on a change in a voltage induced in a coil of wire.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a top-down view of an apparatus for angular-position sensing of a target, according to one or more examples;

FIG. 2 is a top-down view of the apparatus of FIG. 1 with the target removed;

FIG. 3 is a perspective view of the apparatus of FIGS. 1 and 2 with the target removed;

FIGS. 4A, 4B, 4C, and 4D are top-down views of a first sensor including a first set or coils of the apparatus of FIGS. 1, 2, and 3, according to one or more examples;

FIGS. 5A, 5B, 5C, and 5D are top-down views of a second sensor including a second set or coils of the apparatus of FIGS. 1, 2, and 3, according to one or more examples;

FIG. 6 is a schematic diagram of a position sensing circuitry of the apparatus of FIGS. 1, 2, and 3, according to one or more examples;

FIG. 7 is a flowchart of a method of operation of an apparatus for angular-position sensing of a target, according to one or more examples;

FIG. 8 is a flowchart of a method of operation of an apparatus for angular-position sensing of a target, according to one or more examples;

FIG. 9 is a graph of simulated demodulated output waveforms of an inductive angular-position sensor apparatus as a function of angular mechanical position of a target, according to one or more examples;

FIG. 10 is a close-up view of the target of the apparatus of FIGS. 1, 2, and 3, according to one or more examples;

FIG. 11 is a flowchart of a method of providing a target for an inductive angular-position sensing apparatus, according to one or more examples;

FIGS. 12A, 12B, and 12C are top-down views of targets having respective target patterns to better illustrate the method of FIG. 11, according to one or more examples;

FIGS. 13A, 13B, and 13C are top-down views of alternative targets having respective target patterns to further illustrate the method of FIG. 11, according to one or more examples;

FIGS. 14A, 14B, and 14C are top-down views of additional alternative targets having respective target patterns to further illustrate the method of FIG. 11, according to one or more examples;

FIG. 15 is a top-down view of an apparatus for inductive angular-position sensing that is known by the inventors of this disclosure; and

FIG. 16 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Position sensors, including angular-position sensors are useful. Some examples relate to a non-contacting planar inductive sensor for measuring the position of a movable target. There are many advantages to planar inductive sensing technology, such as: contactless sensing technology, easily designed on printed circuit board (PCB) with a metallic object (e.g., formed of a metal sheet) as target, suitable for harsh environments, cost effective, resistance to magnetic fields, immune to electromagnetic interference (EMI)/electromagnetic compatibility (EMC).

An inductive angular-position sensor may include an oscillator, one or more excitation coils or oscillator coils, a first sense coil, a second sense coil, and an integrated circuit (e.g., including position sensing circuitry). Such an inductive angular-position sensor may determine an angular-position of a target relative to the one or more oscillator coils and/or the sense coils. The oscillator may be configured to generate an excitation signal. The one or more oscillator coils may be excited by the excitation signal. The oscillating signal on the one or more oscillator coils may generate a changing (alternating) magnetic field near and especially within a space encircled by the oscillator coil. The first sense coil and the second sense coil may each encircle a space in which the one or more oscillator coils are capable of generating magnetic field, e.g., a space within the space encircled by the one or more oscillator coils. The changing magnetic field generated by the one or more oscillator coils may induce a first oscillating voltage at ends of the first sense coil and a second oscillating voltage at ends of the second sense coil. The first oscillating voltage at the ends of the first sense coil may oscillate in response to the oscillation of the excitation signal and may be a first sense signal. The second oscillating voltage at the ends of the second sense signal may oscillate in response to the oscillation of the excitation signal and may be a second sense signal.

The target may be positioned relative to the one or more oscillator coils, the first sense coil, and the second sense coil. For example, the target, or a portion of the target, may be positioned above a portion of the one or more oscillator coils, the first sense coil, and the second sense coil, without limitation. The target may disrupt some of the changing magnetic field that passes through one or more loops of the first sense coil and the second sense coil.

The first sense coil and the second sense coil may be configured such that the location of the target, or the portion of the target, above one or more of the first sense coil and the second sense coil may affect the first sense signal and the second sense signal induced in the first sense coil and the second sense coil, respectively. For example, the target may disrupt magnetic coupling between the oscillator coil and the sense coils. Such disruption may affect a magnitude of the sense signals in the sense coils. For example, in response to the target, or a the portion of the target, being over a loop in the first sense coil, the amplitude of the first sense signal may be less than the amplitude of the first sense signal when the target is not over the loop in the first sense coil.

The target may be configured to rotate (e.g., around an axis, without limitation) such that a portion of the target may pass over one or more loops of one or more of the one or more oscillator coils, the first sense coil and the second sense coil. As the target rotates, each of the first sense signal of the first sense coil and the second sense signal of the second sense coil may be amplitude modulated in response to the rotation of the target and in response to the portion of the target passing over the loops.

The integrated circuit may be configured to generate an output signal responsive to the first sense signal and the second sense signal. The output signal may be a fraction of a rail voltage based on the first sense signal and the second sense signal. The output signal may be related to an angular-position of the target, or the position of the portion of the target, and successive samples of the output signal may be related to a direction of movement of the target. Thus, the inductive angular-position sensor may be configured to generate an output signal indicative of an angular-position of a target. In some examples, the integrated circuit may be configured to generate a first output signal based on the first sense signal and a second output signal based on the second sense signal. The first output signal may be the first sense signal demodulated; the second output signal may be the second sense signal demodulated. Together, the two output signals may be related to an angular-position of the target and subsequent samples of the first and second output signals may be indicative of rotation of the target. In some examples, the integrated circuit may be configured to generate a single output signal based on the first sense signal and the second sense signal. Some examples include sense coils and/or targets that cause an integrated circuit to generate a constant-slope output signal in response to rotation of the target, relative to the first sense coil and the second sense coil. The constant-slope output signal may be an output signal with a known correlation between an amplitude of the output signal and the angular-position of the target.

In some examples, sense coils and/or targets may be provided with shapes that cause sense signals from the respective sense coils to exhibit desirable waveform shapes, e.g., waveform shapes that may be ideal (or close-to-ideal) waveform shapes. The shapes of targets and/or path portions of the sense coils may be related to how the sense signals generated therein are amplitude-modulated as a target disrupts magnetic field between the oscillator coil and the sense coils. As a non-limiting example, as a target rotates above sense coils and disrupts the magnetic field between the oscillator coil and the sense coils, the shape of the target and/or the sense coils may determine the shape of an amplitude-modulation envelope exhibited by the sense signals. As a non-limiting example, an amplitude-modulation envelope of sense signals of sense coils of various examples may be close to a sinusoidal shape. A sinusoidally-shaped amplitude-modulation envelope may be well-suited for translation into an angular-position, e.g., through a trigonometric function e.g., arctangent.

While known inductive angular-position sensors may include some of the above-described capabilities, various applications require sensors to have high resolution capabilities. For example, in the industrial, medical, space and defense industries, sensor solutions providing high precision and resolution are desirable. For example, high-resolution encoders are significant in robotics for accurate control of robotic arms, joints, and movements. They enable robots to navigate and manipulate objects with precision. In manufacturing processes, such as computer numerical control (CNC) machining and 3D printing, high-resolution encoders help ensure accurate positioning of tools and components, resulting in high-quality and precise output. Medical equipment often requires precise positioning, such as in robotic surgery systems or imaging devices. High-resolution encoders contribute to the accuracy and safety of these medical technologies. In the aerospace industry, where precision is paramount, high-resolution encoders are used in various applications, including aircraft navigation systems, satellite positioning, and control systems. In modern vehicles, high-resolution encoders play a role in advanced driver assistance systems (ADAS), autonomous vehicles, and engine control systems, providing accurate information for navigation and control. High-resolution encoders are also used in scientific instruments and laboratory equipment for precise measurements and positioning in experiments and research.

Various applications of the disclosure may also be provided for motor control (e.g., for rotor position sensing of motors, where the sensors are mounted inside of an assembly). For example, various examples may be provided for through-shaft sensing, with low form-factor PCBs. However, the various examples of the disclosure are not limited to the above-described applications.

According to one or more examples of the disclosure, an inductive angular-position sensing apparatus includes multiple (e.g., two or more) inductive angular-position sensors to sense an angular-position(s) of a target (e.g., a single target).

In one or more examples, the apparatus comprises a first inductive angular-position sensor for first angular-position sensing (e.g., M pole pair sensing) of the target and a second inductive angular-position sensor for second angular-position sensing (e.g., N pole pair sensing) of the target. In one or more further examples, the first inductive angular-position sensing provides a coarse resolution measurement of the angular-position of the target and the second inductive angular-position sensing provides a fine resolution measurement of the angular-position of the target.

In one or more examples, the target of the inductive angular-position sensing apparatus includes a target body having a combined M and N pole pair pattern, where the combined M and N pole pair pattern is a combination of an M pole pair pattern and an N pole pair pattern.

In a specific, non-limiting example, the inductive angular-position sensing apparatus is adapted to measure an index of the target (e.g., using one (1) pole pair for a coarse resolution measurement) together with a fine or high resolution angular-position of the same target (e.g., greater than one (1) pole pair, such as equal to or greater than four (4) pole pairs).

Thus, in one or more examples, the inductive angular-position sensing apparatus may be provided for high resolution, embedded sensing applications. In one or more examples, the apparatus provides a low-cost solution which reduces the size of a substrate (e.g., PCB) of the sensing apparatus. In one or more examples, the proposed solution may simplify a mechanical assembly of the sensing apparatus.

Other various examples of the disclosure are directed to related apparatuses, targets, and methods of inductive angular-position sensing.

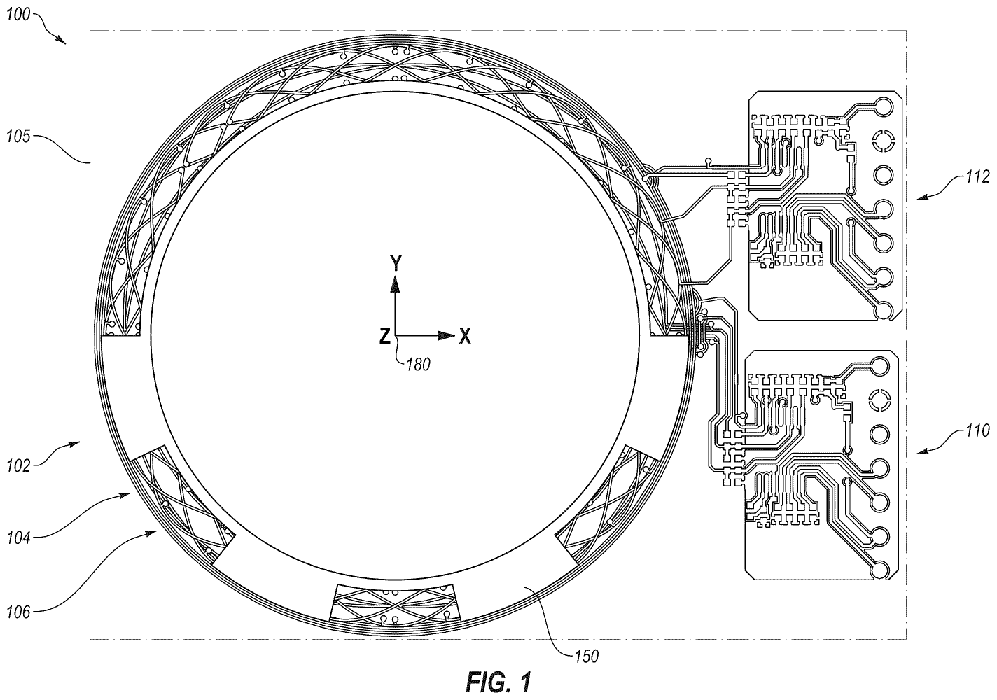

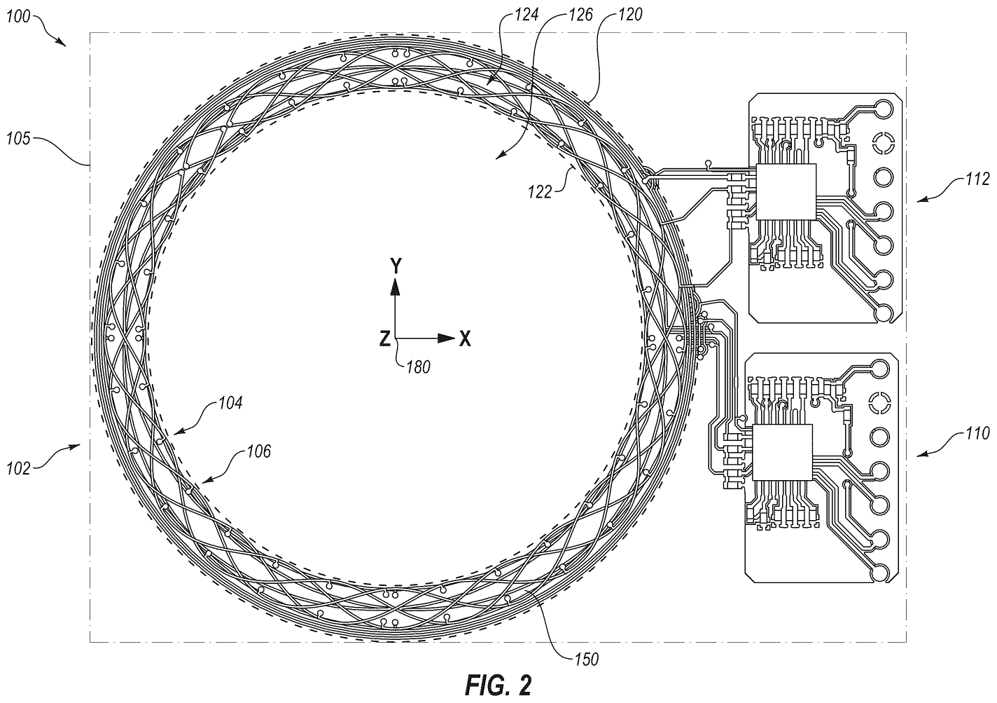

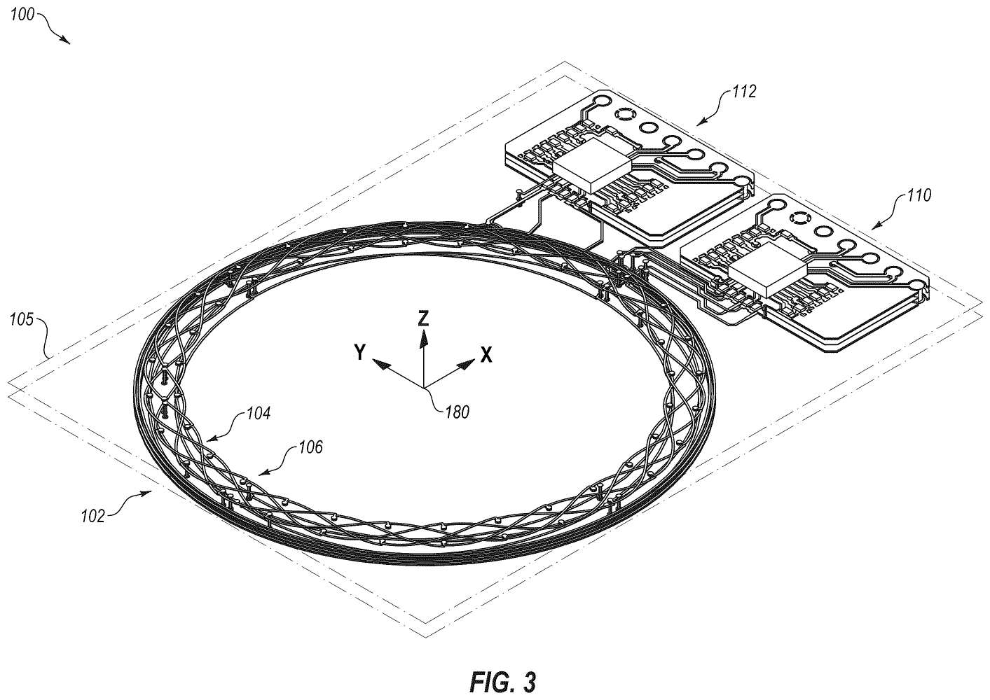

FIG. 1 is a top-down view of an apparatus 100 according to one or more examples of the disclosure. In one or more examples, apparatus 100 is an inductive angular-position sensing apparatus for angular-position sensing of a target 150 adapted to rotate about an axis 180 (e.g., a central axis). FIG. 2 is a top-down view of apparatus 100 of FIG. 1 with the target removed. FIG. 3 is a perspective view of apparatus 100 of FIGS. 1 and 2 with the target removed. In these figures, axis 180 is indicated as the Z-axis in a three-dimensional coordinate axis system (X-Y-Z), where the Z-axis is perpendicular to a plane defined by support structure 105.

In one or more examples, apparatus 100 comprises at least two inductive angular-position sensors to sense an angular-position of target 150. In the example of FIGS. 1, 2, and 3, apparatus 100 includes a first inductive angular-position sensor (“first sensor”) adapted for first inductive angular-position sensing of target 150 and a second inductive angular-position sensor (“second sensor”) for second inductive angular-position sensing of target 150.

In general, apparatus 100 comprises a support structure 105, multiple coils 102, and target 150. Multiple coils 102 include a first set of coils 104 associated with the first sensor and a second set of coils 106 associated with the second sensor. In one or more examples, first set of coils 104 and second set of coils 106 are planar coils. First set of coils 104 of the first sensor are disposed on, or in, support structure 105. Similarly, second set of coils 106 of the second sensor are disposed on, or in, support structure 105. In one or more examples, support structure 105 may be or include a substrate, such as a PCB.

In one or more specific examples, first set of coils 104 are at least partially formed by or include conductive traces on and/or in one or more planes (e.g., multiple planes) of support structure 105 (e.g., the PCB). Similarly, second set of coils 106 are at least partially formed by or include conductive traces on and/or in the one or more planes (e.g., multiple planes) of support structure 105. When multiple planes are used for coil arrangements, the multiple planes may be parallel planes at different heights of the substrate. For example, a respective one of the multiple planes may be associated with a different one of multiple layers of the PCB.

In one or more examples, first set of coils 104 of the first sensor and second set of coils 106 of the second sensor are arranged within an annulus 124 (FIG. 2) centered about axis 180. In FIG. 2, annulus 124 is defined by an outer circle 120 and an inner circle 122 indicated as dashed lines. In one or more examples, outside of annulus 124, a circular region 126 defined within inner circle 122 may be without (e.g., void of) coils and/or without (e.g., void of) target material. In one or more specific examples, circular region 126 may be used for through-shaft insertion of a through-shaft (not shown). In one or more alternative examples, at least a portion of circular region 126 may include dielectric material of target 150 and/or support structure 105 (e.g., in an inner annulus).

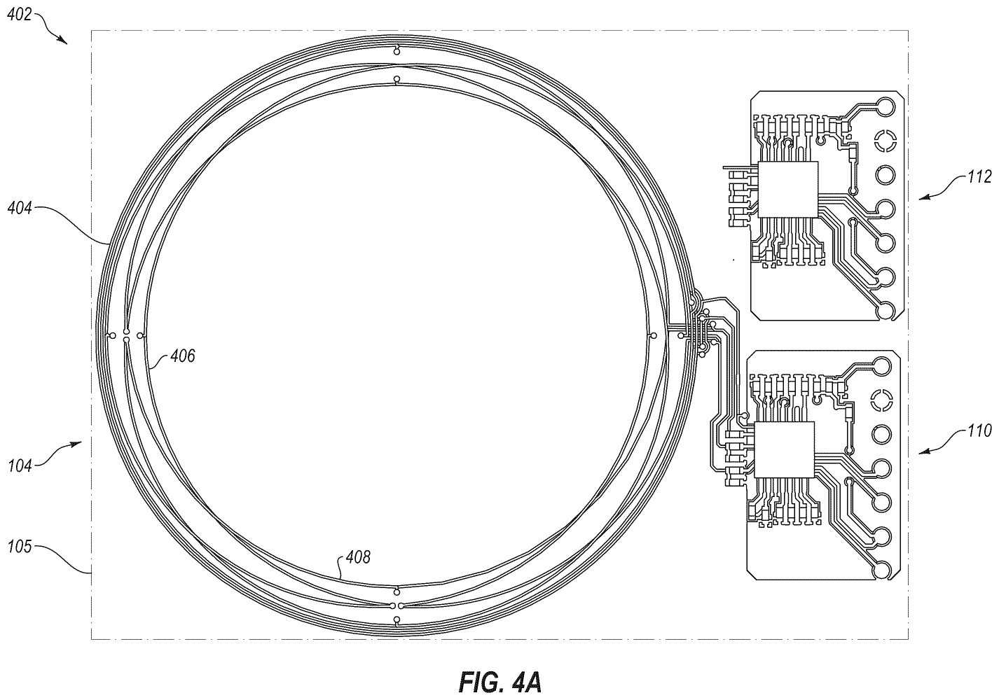

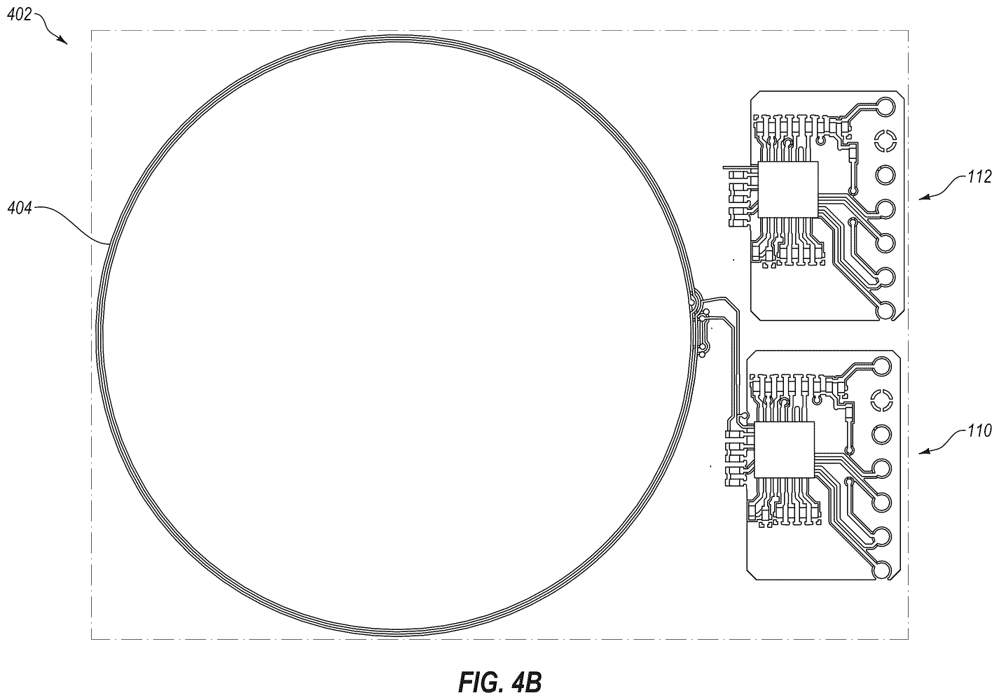

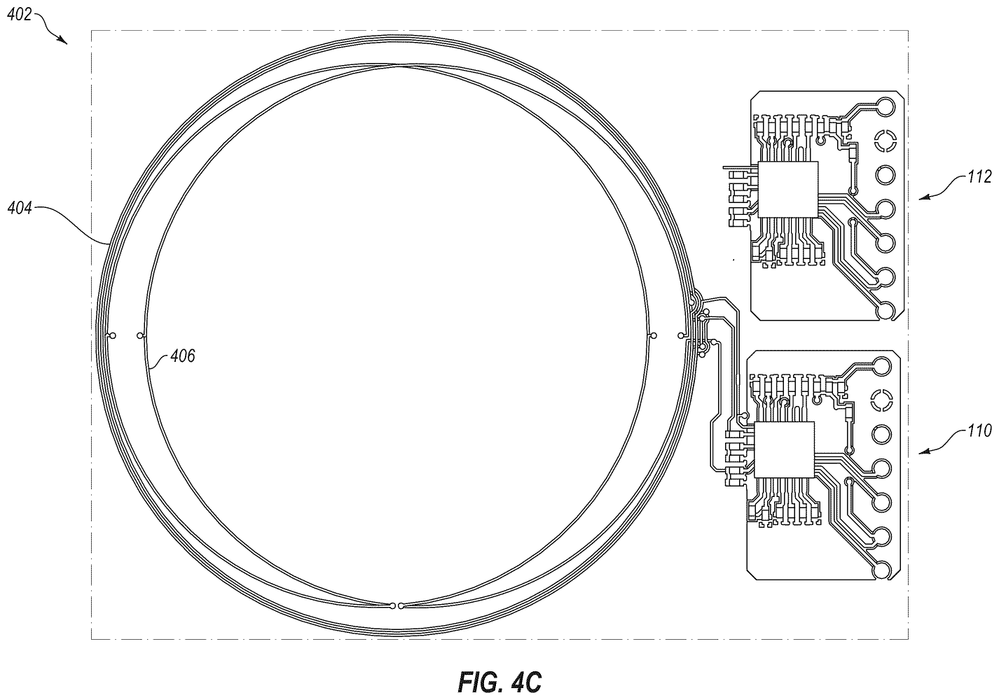

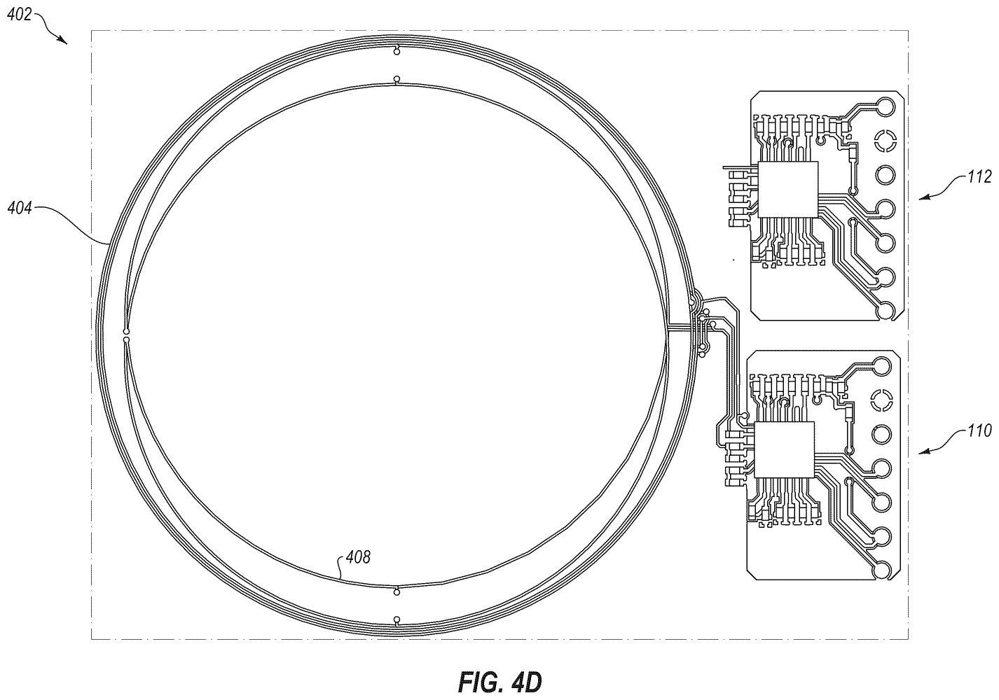

First set of coils 104 of the first sensor include one or more first oscillator coils, a first sense coil, and a second sense coil (e.g., refer ahead to FIG. 4A depicting first set of coils 104 of a first sensor 402, which include one or more first oscillator coils 404, a first sense coil 406, and a second sense coil 408). In one or more examples, respective ones of the first and the second sense coils have one or more M pole pairs, where M is a positive integer. Accordingly, the first sensor may be considered to be an M pole pair sensor. Note that the one or more first oscillator coils, the first sense coil, and the second sense coil of first set of coils 104 are more clearly depicted and described later in relation to FIGS. 4A, 4B, 4C, and 4D, according to one or more examples of the disclosure.

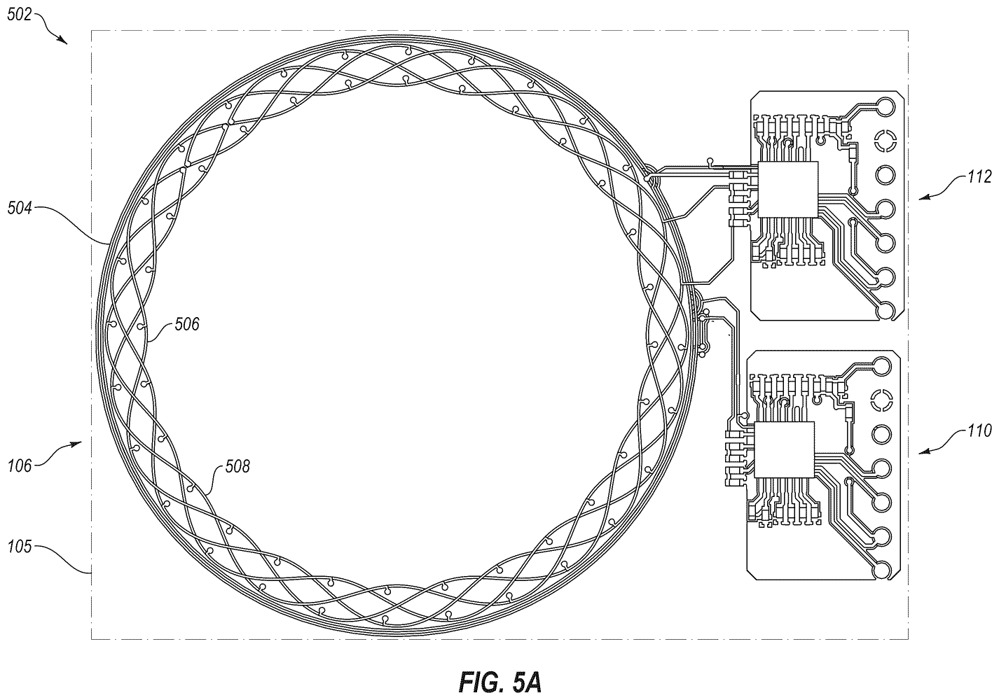

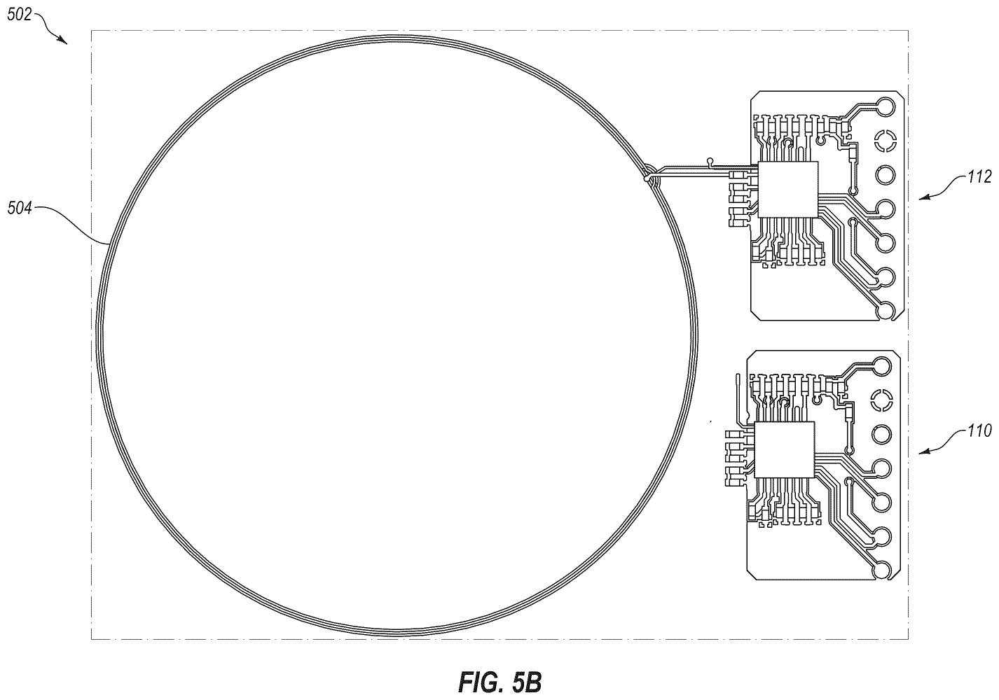

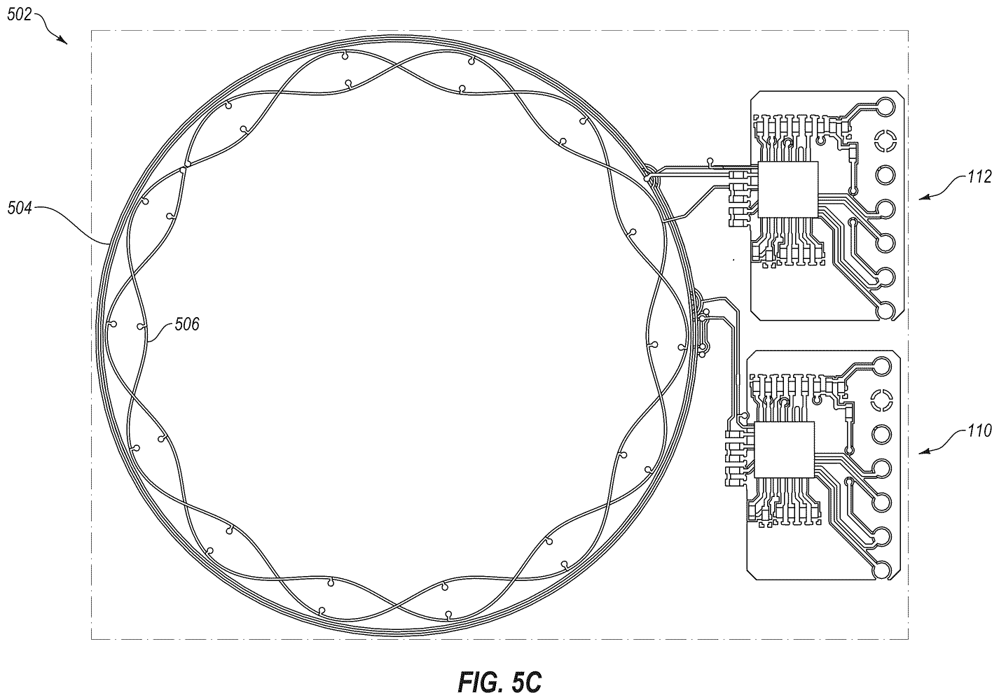

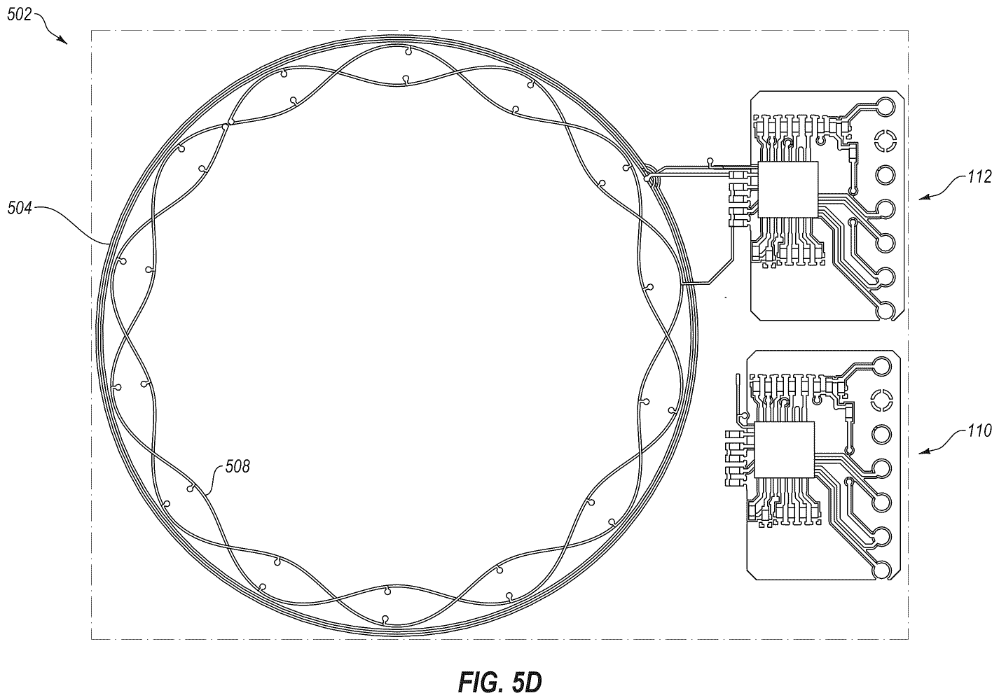

Second set of coils 106 of the second sensor include one or more second oscillator coils, a third sense coil, and a fourth sense coil (e.g., refer ahead to FIG. 5A depicting second set of coils 106 of a second sensor 502, which include one or more second oscillator coils 504, a third sense coil 506, and a fourth sense coil 508). In one or more examples, respective ones of the third and the fourth sense coils have N pole pairs, where N is a positive integer greater than M. Accordingly, the second sensor may be considered to be an N pole pair sensor. In one or more examples, second set of coils 106 may be said to share the same general planar annular region as, and/or be generally coextensive with, first set of coils 104. Note that the one or more second oscillator coils, the third sense coil, and the fourth sense coil of second set of coils 106 are more clearly depicted and described later in relation to FIGS. 5A, 5B, 5C, and 5D, according to one or more examples of the disclosure.

Thus, in the one or more examples of FIGS. 1, 2, and 3, apparatus 100 is to provide first inductive angular-position sensing associated with a first measurement resolution range and second inductive angular-position sensing associated with a second measurement resolution range. More specifically, the first sensor is adapted for sensing a first angular-position of the target with a first measurement resolution (e.g., according to the one or more M pole pairs of first set of coils 104) and the second sensor is adapted for sensing a second angular-position of the target with a second measurement resolution (e.g., according to the N pole pairs of second set of coils 106). In one or more specific examples, the first angular-position has a coarse measurement resolution and the second angular-position has a fine measurement resolution.

Referring back to FIG. 1, target 150 has a target body which is generally planar (i.e., in-plane with the page). The target body is also a generally (partially) annular or semi-annular body (e.g., generally coextensive with annulus 124 indicated in FIG. 2). The target body (i.e., at least the fins thereof) may be made of a conductive material, such as a non-magnetic conductive metal or metal alloy, without limitation. In one or more specific examples, the non-magnetic conductive metal or metal alloy may be or include copper or aluminum. In one or more specific examples, the target body has a fully annular body where the fins thereof are made of conductive material and the non-fin areas are made of non-conductive material. In one or more other examples, the target body of target 150 may be made of a magnetic conductive metal or metal alloy, such as carbon steel or ferritic stainless steel, without limitation. Here, for example, an oscillator may generate an excitation signal within a certain range of frequencies that the magnetic domains of the magnetic conductive metals or metal alloys will not react to.

In one or more examples, the target body of target 150 defines a target pattern to accommodate both the first angular-position sensing and the second angular-position sensing. In one or more examples, the target pattern is a combined M and N pole pair pattern, where the combined M and N pole pair pattern comprises a combination of an M pole pair pattern and an N pole pair pattern.

In the specific, non-limiting example of FIG. 1, the target body comprises an (e.g., inner) annular ring and one or more fin regions, where respective fin regions of the one or more fin regions include a number of fins radially extending from the annular ring. For the first angular-position sensing, the one or more fin regions of the target body define the M pole pair pattern; and for the second angular-position sensing, the number of fins in the respective fin regions of the one or more fin regions define the N pole pair pattern.

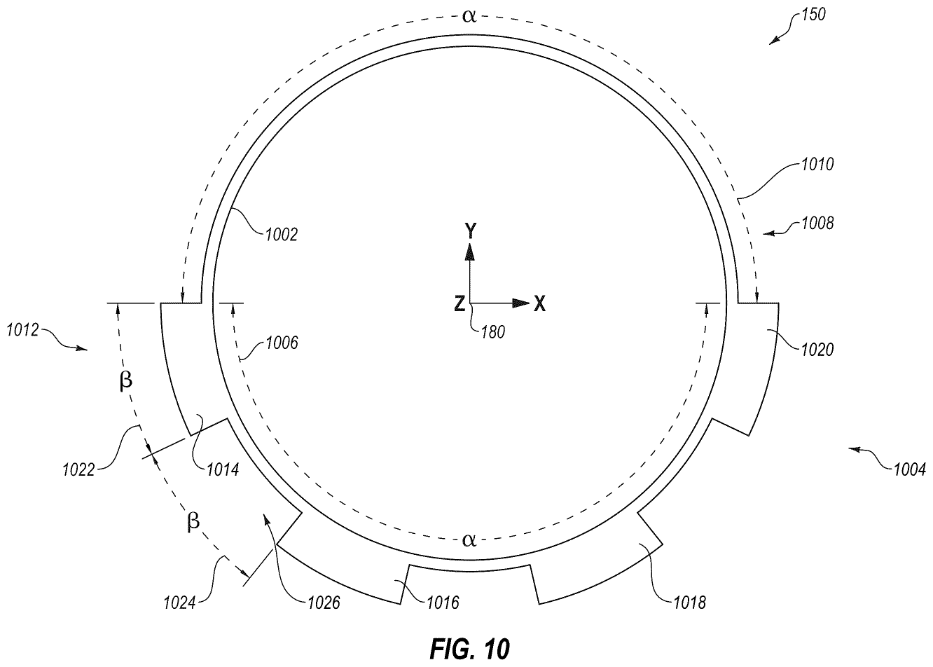

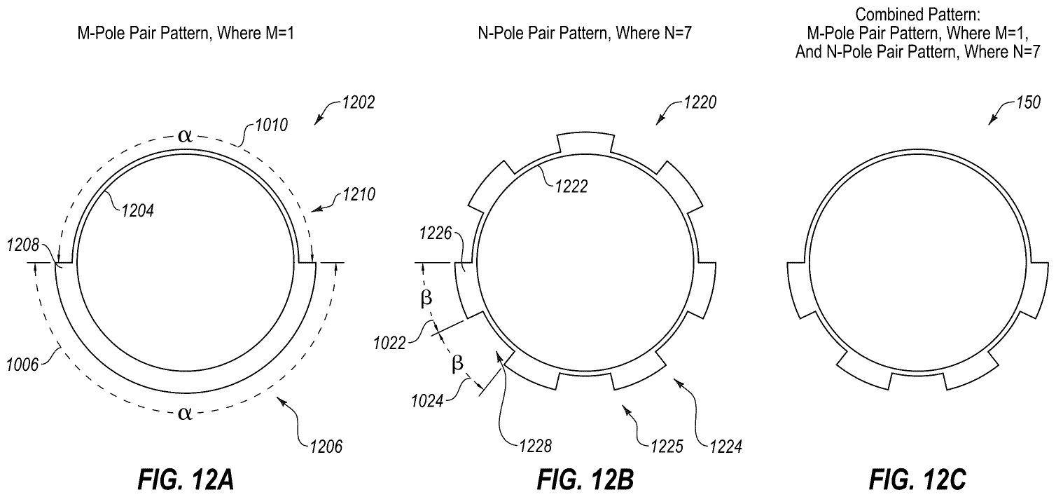

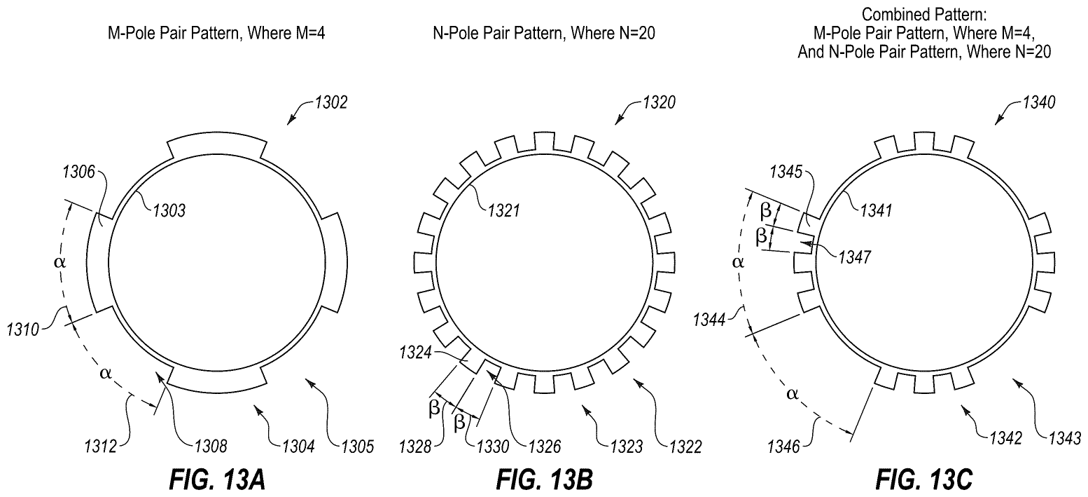

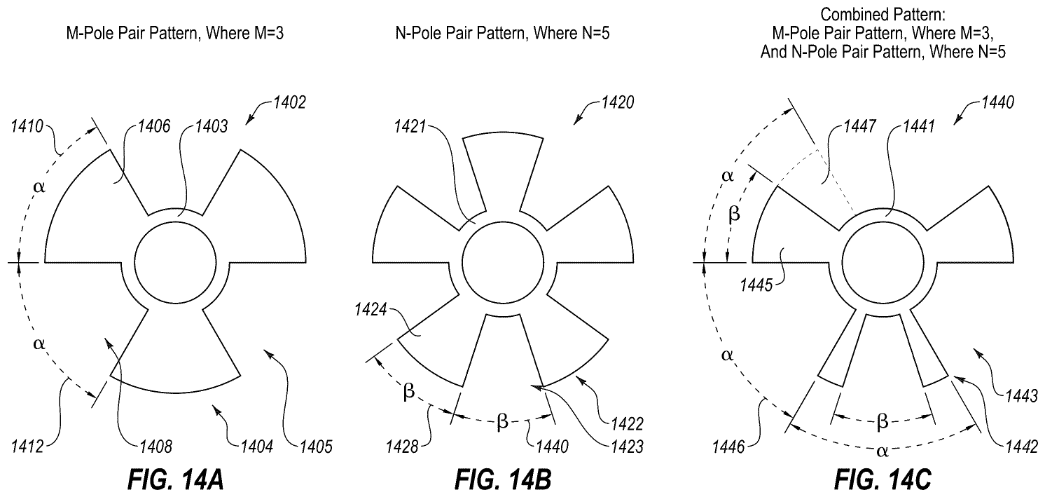

More specifically in FIGS. 1, M=1 and N=7. Thus, target 150 of FIG. 1 has one (1) fin region that defines a one (1) pole pair pattern, and the one (1) fin region has four (4) fins that define a seven (7) pole pair pattern (e.g., the number of fins have respective arc lengths and aperture lengths corresponding to a seven (7) pole pair pattern). Accordingly, the first sensor of apparatus 100 is a one (1) pole pair sensor (i.e., M=1) to provide a coarse angular-position measurement (e.g., over a measurement range of 360/M=360 degrees) and the second sensor of apparatus 100 is a seven (7) pole pair sensor to provide a fine angular-position measurement (e.g., over a measurement range of 360/N=51.42 degrees). Note that the specific target pattern of target 150 is described in more detail in relation to FIG. 10 and FIGS. 12A, 12B, and 12C, and additional example patterns and variations are described in relation to FIGS. 13A, 13B, and 13C and FIGS. 14A, 14B, and 14C later below.

In general, when apparatus 100 of FIGS. 1, 2, and 3 is in operational use, target 150 rotates around axis 180. In a specific, non-limiting example, target 150 may be connected to a through-shaft which may extend through support structure 105 (e.g., a through-hole of apparatus 100 may have a relatively large radius to accommodate the through-shaft). In general, target 150 may disrupt magnetic coupling between the oscillator coils and the sense coils of each sensor, such that sense signals induced in the sense coils are indicative of an angular-position of target 150 as it rotates around axis 180. The degree to which target 150 disrupts magnetic coupling between the oscillator coils and the sense coils of each sensor may vary at least partially in response to changes in the angular-position of target 150.

For angular-position sensing of target 150, the first sensor may include position sensing circuitry 110. Similarly, the second sensor may include position sensing circuitry 112 for angular-position sensing. In one or more examples, position sensing circuitry 110 of the first sensor may be or include a first sensor IC, and position sensing circuitry 112 of the second sensor may also be or include a second sensor IC. In one or more examples, position sensing circuitry 110 of the first sensor and the position sensing circuitry 112 of the second sensor may be (at least partially) included within separate sensor ICs, as shown and described in the examples of FIGS. 1-3, 4A-4D, and 5A-5D. Alternatively, in one or more examples, the position sensing circuitry for the first sensor and the second sensor are provided within a single IC. When provided within a single IC, the single IC may be responsible for generating the excitation signals, processing the received sense signals, and calculating the angular-position using the arctan 2 function or similar algorithms, as discussed below.

Contemplated operation of position sensing circuitry 110 of the first sensor is now described. In such operation, position sensing circuitry 110 generates a high frequency signal to excite the one or more first oscillator coils of first set of coils 104 for producing an alternating magnetic field. The magnetic field couples onto the first and the second sense coils of first set of coils 104 for generating respective voltage signals. As target 150 disturbs the generated magnetic field, the first and the second sense coils will receive different voltage signals versus target position. When target 150 is present and is rotating, it creates modulated sine and cosine waveforms given as feedback signals to position sensing circuitry 110 (e.g., the IC). Internal to the IC, the signals are demodulated to produce demodulated first and second position signals. The demodulated first and second position signals may indicate the target's angular-position which is sensed by the circuitry. Position information may be calculated, for example, by taking an arctan 2 function of the ratio of the demodulated first and second position signals. In this manner, the angular-position of target 150 may be detected.

Contemplated operation of position sensing circuitry 112 of the second sensor is now described, which is the same as or similar to the operation of position sensing circuitry 110 of the first sensor. In such operation, position sensing circuitry 112 generates a high frequency signal to excite the one or more second oscillator coils of second set of coils 106 for producing an alternating magnetic field. In one or more examples, the frequency used for second set of coils 106 is different from the frequency used for first set of coils 104. The magnetic field couples onto the third and the fourth sense coils of second set of coils 106 for generating respective voltage signals. As target 150 disturbs the generated magnetic field, the third and the fourth sense coils will receive different voltage signals versus target position. When target 150 is present and is rotating, it creates modulated sine and cosine waveforms given as feedback signals to position sensing circuitry 112 (e.g., the IC). Internal to the IC, the signals are demodulated to produce demodulated third and fourth position signals. The demodulated third and fourth position signals may also indicate the target's angular-position which is sensed by the circuitry. Position information may be calculated, for example, by taking an arctan 2 function of the ratio of the demodulated third and fourth position signals. In this manner, the angular-position of target 150 may further be detected.

FIGS. 4A, 4B, 4C, and 4D are top-down views of a first sensor 402 including first set or coils 104 of apparatus 100 of FIGS. 1, 2, and 3, according to one or more examples. In one or more examples of FIGS. 4A, 4B, 4C, and 4D, first sensor 402 is a one (1) pole pair sensor (i.e., M=1).

More particularly, FIG. 4A is a top-down view of first set of coils 104 of first sensor 402 which includes one or more first oscillator coils 404, a first sense coil 406, and a second sense coil 408, according to one or more examples. FIG. 4B is a top-down view of one or more first oscillator coils 404 of the first set of coils of FIG. 4A with the first sense coil and the second sense coil removed. FIG. 4C is a top-down view of one or more first oscillator coils 404 and first sense coil 406 of the first set of coils of FIG. 4A with the second sense coil removed. FIG. 4D is a top-down view of one or more first oscillator coils 404 and second sense coil 408 of the first set of coils of FIG. 4A with the first sense coil removed. One or more first oscillator coils 404 may be referred to as primary coils, and first and second sense coils 406 and 408 may be referred to as secondary coils.

For first sensor 402, one or more first oscillator coils 404 (FIG. 4B) are arranged around the axis in a circular pattern as or along an outer boundary of the annulus (e.g., outer circle 120 and axis 180 of FIG. 2). One or more first oscillator coils 404 define a circular path for electrical current to flow. First sense coil 406 (FIG. 4C) defines first lobes (e.g., 2*M first lobes) arranged around the axis within the annulus for electrical current to flow. The first lobes of first sense coil 406 have peaks and valleys extending between the outer circle and the inner circle of the annulus, respectively. In one or more examples, the first lobes of first sense coil 406 comprise a positive lobe of a forward path and a negative lobe of a return path. Second sense coil 408 (FIG. 4D) defines second lobes (e.g., 2*M second lobes) arranged around the axis of rotation within the annulus for electrical current to flow. The second lobes have peaks and valleys extending between the outer circle and the inner circle of the annulus, respectively. In one or more examples, the second lobes of second sense coil 408 comprise a positive lobe of a forward path and a negative lobe of a return path. The first and the second lobes of first and second sense coils 406 and 408 are substantially surrounded by the circular pattern of one or more first oscillator coils 404. In one or more examples, respective ones of the first lobes of first sense coil 406 and the second lobes of second sense coil 408 are mechanical offset (e.g., by 90/M degrees, or 90/1=90 degrees) so as to produce sinusoidal wave signals that are 90 degrees out-of-phase with each other.

FIGS. 5A, 5B, 5C, and 5D are top-down views of a second sensor 502 including second set of coils 106 of apparatus 100 of FIGS. 1, 2, and 3, according to one or more examples. In one or more examples of FIGS. 5A, 5B, 5C, and 5D, second sensor 502 is a seven (7) pole pair sensor (i.e., N=7).

More particularly, FIG. 5A is a top-down view of second set of coils 106 of second sensor 502 which includes one or more second oscillator coils 504, a third sense coil 506, and a fourth sense coil 508, according to one or more examples. FIG. 5B is a top-down view of one or more second oscillator coils 504 of the second set of coils of FIG. 5A with the third sense coil and the fourth sense coil removed. FIG. 5C is a top-down view of one or more second oscillator coils 504 and third sense coil 506 of the second set of coils of FIG. 5A with the fourth sense coil removed. FIG. 5D is a top-down view of one or more second oscillator coils 504 and fourth sense coil 508 of the second set of coils of FIG. 5A with the third sense coil removed. One or more second oscillator coils 404 may be referred to as primary coils, and third and fourth sense coils 506 and 508 may be referred to as secondary coils.

For second sensor 502, one or more second oscillator coils 504 (FIG. 5B) are arranged around the axis in a circular pattern as or along the outer boundary of the annulus (e.g., outer circle 120 and axis 180 of FIG. 2). One or more second oscillator coils 504 define a circular path for electrical current to flow. Third sense coil 506 (FIG. 5C) defines a substantially-sinusoidal-wave-shaped path for electrical current to flow. The substantially-sinusoidal-wave-shaped path defines third lobes (e.g., 2*N third lobes) arranged around the axis within the annulus. The third lobes of third sense coil 506 has peaks and valleys extending between the outer circle and the inner circle of the annulus, respectively. In one or more examples, the third lobes of third sense coil 506 comprise positive lobes of a forward path and negative lobes of a return path. Fourth sense coil 508 (FIG. 5D) also defines a substantially-sinusoidal-wave-shaped path for electrical current to flow. The substantially-sinusoidal-wave-shaped path defines fourth lobes (e.g., 2*N fourth lobes) arranged around the axis of rotation within the annulus. The fourth lobes have peaks and valleys extending between the outer circle and the inner circle of the annulus, respectively. In one or more examples, the fourth lobes of fourth sense coil 508 comprise positive lobes of a forward path and negative lobes of a return path. The substantially-sinusoidal-wave-shaped paths of third and fourth sense coils 506 and 508 are substantially surrounded by the circular pattern of one or more second oscillator coils 504. In one or more examples, respective ones of the third lobes of third sense coil 506 and the fourth lobes of fourth sense coil 508 are mechanical offset (e.g., by 90/N degrees, or 90/7=12.86 degrees) so as to produce sinusoidal wave signals that are 90° out-of-phase with each other.

In a specific-non-limiting example of FIGS. 4A, 4B, 4C, and 4D and FIGS. 5A, 5B, 5C, and 5D, the first sense coil and the second sense coil of the first sensor are formed or otherwise provided in layer one (L1) and layer two (L2) of the support structure (e.g., a PCB), respectively; the third sense coil and the fourth sense coil of the second sensor are formed or otherwise provided in layer three (L3) and layer fourth (L4) of the support structure (e.g., the PCB), respectively; and the one or more first oscillator coils of the first sensor and the one or more second oscillator coils of the second sensor are formed or otherwise provided in layer five (L5) and layer six (L6), respectively.

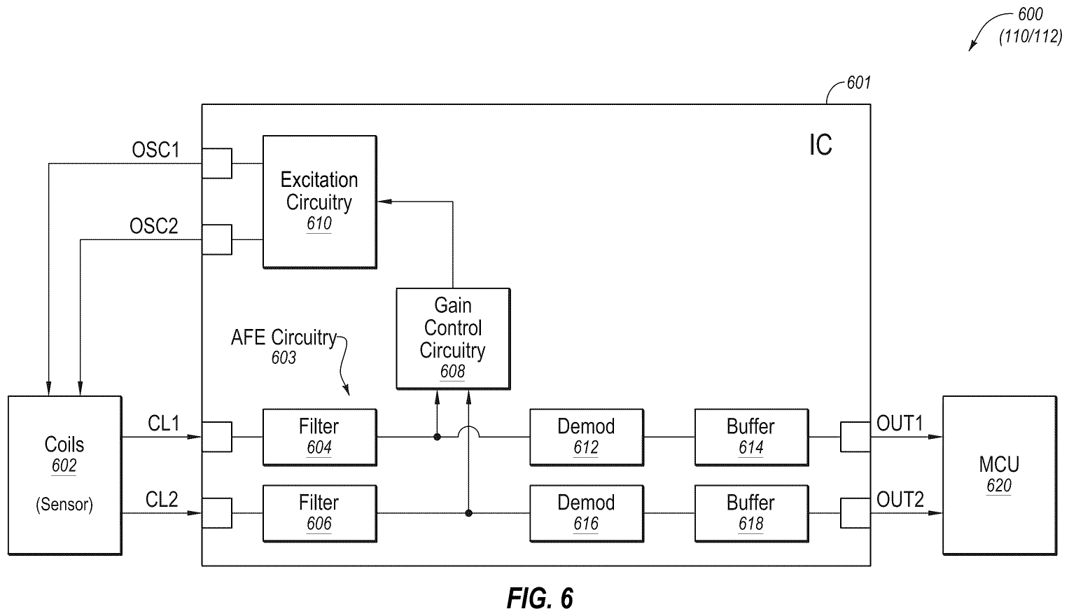

FIG. 6 is a schematic diagram of a position sensing circuitry 600 of apparatus 100 of FIGS. 1, 2, and 3, according to one or more examples. Position sensing circuitry 600 of FIG. 6 may be representative of position sensing circuitry 110 of FIGS. 1, 2, and 3, and/or position sensing circuitry 112 of FIGS. 1, 2, and 3. In one or more examples, an IC 601 may contain or include many or most components of position sensing circuitry 600. In one or more examples, IC 601 used in position sensing circuitry 110 (e.g., FIGS. 1, 2, and 3) is substantially identical to IC 601 used in position sensing circuitry 112 (e.g., FIGS. 1, 2, and 3).

In one or more examples, position sensing circuitry 600 includes an excitation circuitry 610, an analog front-end (AFE) circuitry 603, and a gain control circuitry 608. AFE circuitry 603 may include, for a modulated first sense signal received from the first sense coil of multiple coils 602 (i.e., received at a CL1 input), a filter 604 (e.g., an EMI filter), a demodulator 612, and a buffer circuit 614. AFE circuitry 603 may also include, for a modulated second sense signal received from the second sense coil of multiple coils 602 (i.e., received at a CL2 input), a filter 606 (e.g., an EMI filter), a demodulator 616, and a buffer circuit 618. Gain control circuitry 608 is used to adjust the signal gain of excitation circuitry 610 based at least on the received/modulated first and second sense signals. Demodulated first and second position signals (e.g., indicating a position of the target) may be provided at OUT1 and OUT2 outputs of the IC after passing through buffer circuits 614 and 618, respectively.

Operation will now be described with respect to the first sensor (e.g., where multiple coils 602 are first set of coils 104 of first sensor 402 of FIG. 4A). In general, position sensing circuitry 600 (e.g., position sensing circuitry 110 for the first sensor) is to produce demodulated first and second position signals at least partially based on the modulated first and second sense signals received from the first and the second sense coils (e.g., received at CL1 and CL2 inputs), respectively. More particularly, excitation circuitry 610 generates one or more excitation signals (e.g., at OSC1 and OSC2 outputs of IC 601) in the one or more first oscillator coils of multiple coils 602 to produce a varying magnetic field for inducing the first and second sense signals in the first and the second sense coils, respectively. The first and second sense signals may be first and second sinusoidal signals, respectively, 90° out-of-phase with each other (e.g., cosine signals and sine signals), in one or more examples. The varying magnetic field may be disturbed in accordance with an angular-position of the target which modulates the first and second sense signals in the first and second sense coils. For the first sensor, the varying magnetic field may be disturbed in accordance with the angular-position of the target from its M pole pair pattern.

At IC 601, the modulated first and second sense signals are received from the first and second sense coils (e.g., at the CL1 and CL2 inputs). AFE circuitry 603 receives and processes modulated first and second sense signals. In particular, the modulated first sense signal (received at CL1 input) is filtered through filter 604, demodulated by demodulator 612 to generate the demodulated first position signal, and sent to the OUT1 output through buffer circuit 614. The modulated second sense signal (received at CL2 input) is filtered through filter 606, demodulated by demodulator 616 to generate the demodulated second position signal, and sent to the OUT2 output through buffer circuit 618. The demodulated first and second position signals indicate a first angular-position of the target. Respective ones of the demodulated first and second position signals exhibit one or more M cycles for every full rotation of the target.

In one or more examples, position sensing circuitry 600 includes a processor (e.g., a central processing unit (CPU) not shown in FIG. 6) used to calculate the angular-position of the target at least partially based on the demodulated first and second position signals (e.g., based on an arctan 2 function, without limitation). In one or more other examples, a microcontroller unit (MCU) 620 or an electronic control unit (ECU) may receive the demodulated first and second position signals at the OUT1 and OUT 2 outputs, respectively, and calculate the angular-position of the target at least partially based on the signals (e.g., based on the arctan 2 function, without limitation). Thus, in one or more examples, the angular-position of the target may be detected.

Operation for the second sensor (e.g., where multiple coils 602 are second set of coils 106 of second sensor 502 of FIG. 5A) is substantially the same as or similar to operation for the first sensor. In general, position sensing circuitry 600 (e.g., position sensing circuitry 112 for the second sensor) is to produce demodulated third and fourth position signals at least partially based on the modulated third and fourth sense signals received from the third and the fourth sense coils (e.g., received at CL1 and CL2 inputs), respectively. More particularly, excitation circuitry 610 generates one or more excitation signals (e.g., at OSC1 and OSC2 outputs of IC 601) in the one or more second oscillator coils of multiple coils 602 to produce a varying magnetic field to induce the third and the fourth sense signals in the third and the fourth sense coils, respectively. The third and the fourth sense signals may be third and fourth sinusoidal signals, respectively, 90° out-of-phase with each other (e.g., cosine signals and sine signals), in one or more examples. The varying magnetic field may be disturbed in accordance with an angular-position of the target which modulates the third and the fourth sense signals in the third and the fourth sense coils. For the second sensor, the varying magnetic field may be disturbed in accordance with the angular-position of the target from its N pole pair pattern.

At IC 601, the modulated third and fourth sense signals are received from the third and the fourth sense coils (e.g., at the CL1 and CL2 inputs). AFE circuitry 603 receives and processes modulated third and fourth sense signals. In particular, the modulated third sense signal (received at CL1 input) is filtered through filter 604, demodulated by demodulator 612 to generate the demodulated third position signal, and sent to the OUT1 output through buffer circuit 614. The modulated fourth sense signal (received at CL2 input) is filtered through filter 606, demodulated by demodulator 616 to generate the demodulated fourth position signal, and sent to the OUT2 output through buffer circuit 618. The demodulated third and fourth position signals indicate a second angular-position of the target. Respective ones of the demodulated third and fourth position signals exhibit N cycles for every full rotation of the target.

Again, in one or more examples, position sensing circuitry 600 includes a processor (e.g., a CPU not shown in FIG. 6) used to calculate the angular-position of the target, which is at least partially based on the demodulated third and fourth position signals (e.g., based on the arctan 2 function, without limitation). In one or more other examples, MCU 620 or an ECU may receive the demodulated third and fourth position signals at the OUT1 and OUT 2 outputs, respectively, and calculate the angular-position of the target at least partially based on the signals (e.g., based on the arctan 2 function, without limitation). Thus, in one or more examples, the angular-position of the target may further be detected.

In one or more specific examples, the one or more first oscillator coils of the first sensor may include a first oscillator coil and a second oscillator coil coupled at a common center tap; and similarly the one or more second oscillator coils of the second sensor may include a third oscillator coil and a fourth oscillator coil coupled at a common center tap. Here, the excitation circuitry generates a first excitation signal in the first oscillator coil and a second excitation signal in the second oscillator coil to produce the varying magnetic field which induces the sense signals in the sense coils. In one or more examples, the second excitation signal is substantially 180 degrees out-of-phase with the first excitation signal. Similarly, the excitation circuitry generates a third excitation signal in the third oscillator coil and a fourth excitation signal in the fourth oscillator coil to produce the varying magnetic field which induces the sense signals in the sense coils. In one or more examples, the fourth excitation signal is substantially 180 degrees out-of-phase with the third excitation signal.

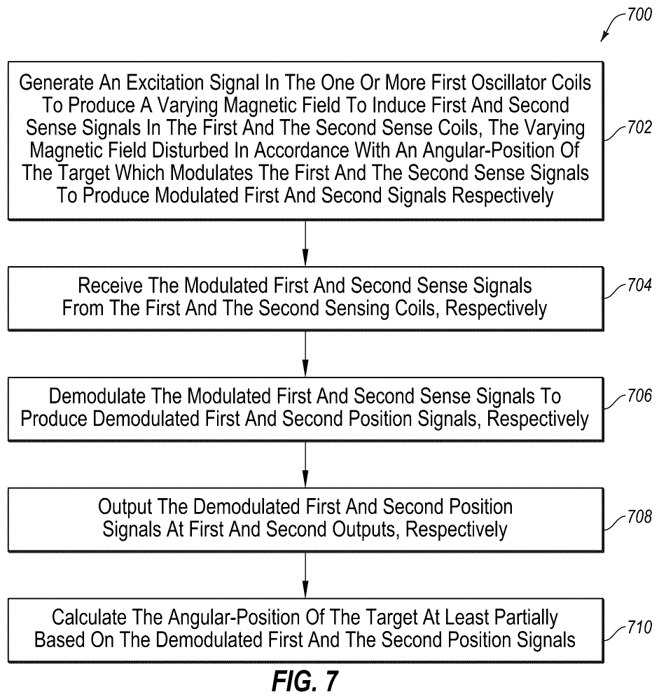

FIG. 7 is a flowchart of a method 700 of operation of an apparatus for angular-position sensing of a target, according to one or more examples. In one or more examples, method 700 may be performed in apparatus 100 of FIGS. 1, 2, and 3 which includes the first sensor (e.g., first sensor 402 of FIGS. 4A, 4B, 4C, and 4D) and the second sensor (e.g., second sensor 502 of FIGS. 5A, 5B, 5C, and 5D).

Acts of method 700 will now be described in relation to the first sensor (e.g., first sensor 402 of FIGS. 4A, 4B, 4C, and 4D). In acts 702, 704, and 706 of FIG. 7, demodulated first and second position signals indicating a first angular-position of a target are produced at least partially based on modulated first and second sense signals from the first and second sense coils, respectively. More specifically, at an act 702, an excitation signal in one or more first oscillator coils is generated to produce a varying magnetic field for inducing the first and second sense signals in the first and second sense coils, respectively. The varying magnetic field may be disturbed in accordance with the angular-position of the target which modulates the first and the second sense signals. In one or more examples, the modulated first and second sense signals may be modulated first and second sinusoidal signals which are substantially 90° out-of-phase with each other. For the first sensor, the varying magnetic field may be disturbed in accordance with the angular-position of the target from its M pole pair pattern.

At an act 704, the modulated first and second sense signals are received from the first and second sense coils, respectively. At an act 706, the modulated first and second sense signals are demodulated to produce the demodulated first and second position signals, respectively. In one or more examples, the demodulated first and second position signals may be demodulated first and second voltage position signals, which may also be differential signals. Respective ones of the demodulated first and second position signals exhibit one or more M cycles for every full rotation of the target. At an act 708, the demodulated first and second position signals are output at first and second outputs, respectively. At an act 710, the first angular-position of the target may be calculated at least partially based on the demodulated first and second position signals. In one or more examples, the first angular-position of the target may be calculated at least partially based on an arctan 2 function (e.g., by taking the arctan 2 function of the ratio of the two signals, without limitation).

The acts for operation of the second sensor (e.g., second sensor 502 of FIGS. 5A, 5B, 5C, and 5D) are substantially the same as or similar to those for the first sensor, and track generally (albeit not precisely) with the description recited in the flowchart of FIG. 7. In general, demodulated third and fourth position signals indicating a second angular-position of the target are produced at least partially based on modulated third and fourth sense signals from the third and the fourth sense coils, respectively. More specifically, at act 702, an excitation signal in the one or more second oscillator coils is generated to produce a varying magnetic field to induce the third and the fourth sense signals in the third and the fourth sense coils, respectively. The varying magnetic field may be disturbed in accordance with the angular-position of the target which modulates the third and the fourth sense signals. In one or more examples, the modulated third and fourth sense signals may be modulated third and fourth sinusoidal signals which are substantially 90° out-of-phase with each other. For the second sensor, the varying magnetic field may be disturbed in accordance with the angular-position of the target from its N pole pair pattern.

At act 704, the modulated third and fourth sense signals are received from the third and the fourth sense coils, respectively. At act 706, the modulated third and fourth sense signals are demodulated to produce the demodulated third and fourth position signals, respectively. In one or more examples, the demodulated third and fourth position signals may be demodulated third and fourth voltage position signals, which may also be differential signals. Respective ones of the demodulated first and second position signals exhibit N cycles for every full rotation of the target. At act 708, the demodulated third and fourth position signals are output at first and second outputs, respectively. At act 710, the second angular-position of the target may be calculated at least partially based on the demodulated third and fourth position signals. In one or more examples, the second angular-position of the target may be calculated at least partially based on an arctan 2 function (e.g., by taking the arctan 2 function of the ratio of the two signals, without limitation).

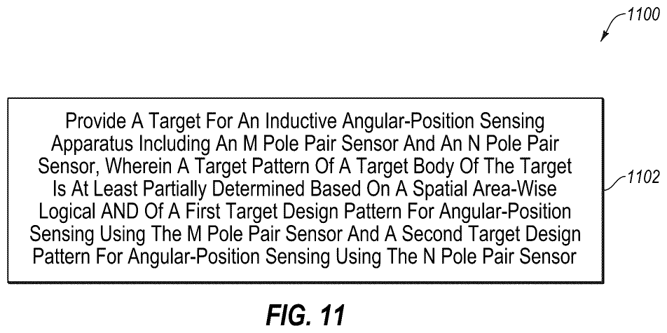

FIG. 8 is a flowchart of a method 800 of operation of an apparatus for angular-position sensing of a target, according to one or more examples. In one or more examples, method 800 may be performed in apparatus 100 of FIGS. 1, 2, and 3. More specifically, method 800 may be performed in apparatus 100 including a first sensor (e.g., a coarse resolution sensor, such as first sensor 402 of FIGS. 4A, 4B, 4C, and 4D) and a second sensor (e.g., a fine resolution sensor, such as second sensor 502 of FIGS. 5A, 5B, 5C, and 5D) according to one or more examples. In one or more examples of FIG. 8, the inductive angular-position sensing apparatus includes a rotatable target including a target body having a combined M and N pole pair pattern, where the combined M and N pole pair pattern comprises a combination of an M pole pair pattern and an N pole pair pattern (e.g., a rotatable target such as target 150 of FIGS. 1 and 12C, or a target 1340 of FIG. 13C, or a target 1440 of FIG. 14C, or other suitable rotatable target designed according to a method 1100 of FIG. 11 in one or more examples).

At an act 802, a first angular-position of the rotatable target is sensed or detected. The first angular-position of the rotatable target is sensed or detected at least partially based on modulated first and second sense signals from first and second sense coils, respectively. The modulated first and second sense signals are modulated according to the M pole pair pattern of the rotatable target. Respective ones of the first and the second sense coils have one or more M pole pairs.

At an act 804, a second angular-position of the rotatable target is sensed or detected. The second angular-position of the rotatable target is sensed or detected at least partially based on modulated third and fourth sense signals from third and fourth sense coils, respectively. The modulated third and fourth sense signals are modulated according to the N pole pair pattern of the rotatable target. Respective ones of the third and the fourth sense coils have N pole pairs.

In one or more examples of act 802, sensing or detecting the first angular-position of the rotatable target comprises detecting or sensing the first angular-position having a first measurement resolution. In one or more examples of act 804, sensing or detecting the second angular-position of the rotatable target comprises sensing or detecting the second angular-position having a second measurement resolution, the second measurement resolution different from the first measurement resolution.

In one or more examples of act 802, sensing or detecting the first angular-position of the rotatable target includes producing demodulated first and second position signals at least partially based on the modulated first and second sense signals, where respective ones of the demodulated first and second position signals exhibit one or more M cycles for every full rotation of the rotatable target. In one or more examples of act 804, sensing or detecting the second angular-position of the rotatable target includes producing demodulated third and fourth position signals at least partially based on the modulated third and fourth sense signals, where respective ones of the demodulated third and fourth position signals exhibit N cycles for every full rotation of the rotatable target.

In one or more examples, method 800 includes providing the rotatable target for the inductive angular-position sensing apparatus. The rotatable target includes the target body comprising an annular ring and one or more fin regions. Respective fin regions of the one or more fin regions include a number of fins radially extending outwardly from the annular ring. The one or more fin regions define the M pole pair pattern, and the number of fins in the respective fin regions of the one or more fin regions define the N pole pair pattern.

In one or more examples, the respective fin regions of the one or more fin regions have an arc length of substantially α degrees, where α=180/M, and respective fins of the number of fins in the respective fin regions having an arc length of substantially β degrees, where β=180/N.

In one or more examples, the target body also has one or more first arcuate apertures between respective adjacent fin regions or fin region of the one or more fin regions. Respective ones of the one or more first arcuate apertures have an arc length of substantially α degrees. The target body also has second arcuate apertures between respective adjacent fins of the number of fins in the respective fin regions, respective ones of the second arcuate apertures having an arc length of substantially β degrees.

In one or more examples, the target pattern of the target body is at least partially based on a spatial area-wise logical AND of a first standard target design pattern and a second standard target design pattern, where the first standard target design pattern is for angular-position sensing using an M pole pair sensor and the second standard target design pattern is for angular-position sensing using an N pole pair sensor.

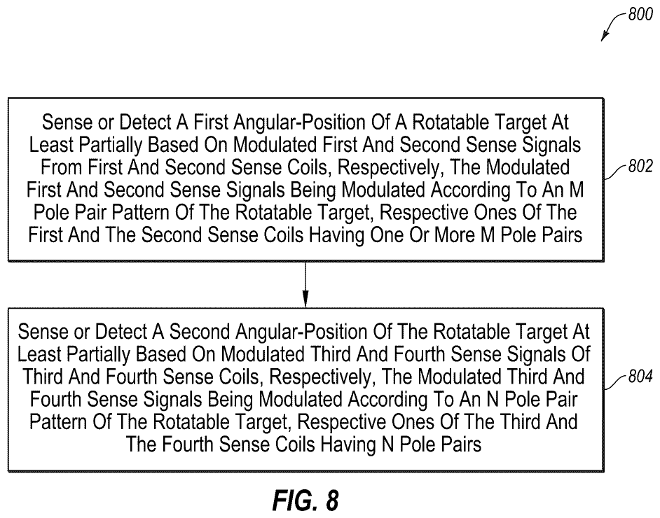

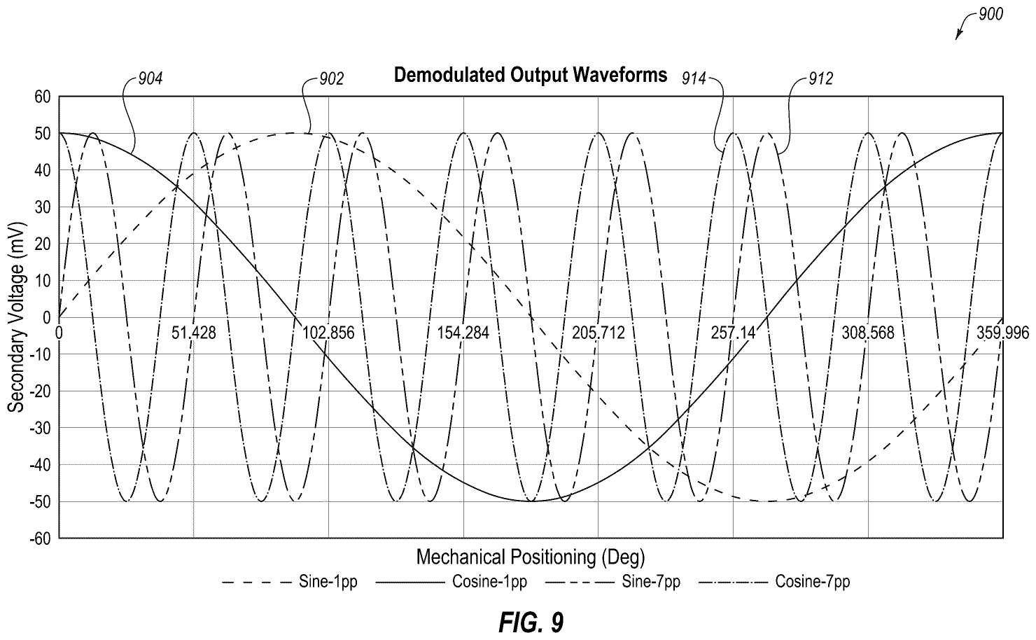

FIG. 9 is a graph 900 of simulated demodulated output waveforms (e.g., secondary voltage signals) of an inductive angular-position sensing apparatus (e.g., apparatus 100 of FIGS. 1, 2, and 3) as a function of angular mechanical position of a target, according to one or more examples. More particularly, graph 900 depicts a demodulated first position signal 902 and a demodulated second position signal 904 of the first sensor (e.g., the one (1) pole pair sensor). Graph 900 further depicts a demodulated third position signal 912 and a demodulated fourth position signal 914 of the second sensor (e.g., the seven (7) pole pair sensor). In the example of FIG. 9, demodulated first and second position signals 902 and 904 are sinusoidal signals that are 90° out-of-phase with each other, and demodulated third and fourth position signals 912 and 914 are also sinusoidal signals that are 90° out-of-phase with each other. As is apparent from the example of FIG. 9, the first sensor associated with demodulated first and second position signals 902 and 904 provides a (e.g., coarse) resolution measurement range of 360 degrees (e.g., one (1) cycle per full rotation of the target). The second sensor associated with demodulated third and fourth position signals 912 and 914 provides a (e.g., fine or high) resolution measurement range of 51.4 degrees (e.g., seven (7) cycles per full rotation of the target).

FIG. 10 is a close-up view of target 150 of apparatus 100 of FIGS. 1, 2, and 3, according to one or more examples. As described herein, target 150 has a target body defining a combined M and N pole pair pattern adapted for angular-position sensing by a first sensor (e.g., an M-pole pair sensor) and angular-position sensing by a second sensor (e.g., an N-pole pair sensor). In one or more examples, the combined M and N pole pair pattern of target 150 comprises a combination of an M pole pair pattern and an N pole pair pattern, where M=1 and N=7.

In the specific example of FIG. 10, the target body of target 150 comprises an annular ring 1002 and one or more fin regions 1004 (i.e., here, a single fin region defined within boundaries of a dashed arrow line 1006). Respective fin regions of one or more fin regions 1004 (i.e., the single fin region depicted in FIG. 10) include a number of fins 1012 (i.e., fins 1014, 1016, 1018, and 1020) radially extending outwardly from annular ring 1002.

In one or more examples, the respective fin regions of one or more fin regions 1004 (i.e., the single fin region depicted in FIG. 10) have an arc length of substantially α degrees, where α=180/M (e.g., M=1, and therefore α=180/1=180 degrees).

In one or more examples, respective fins of the number of fins 1012 (e.g., fin 1014) in a respective fin region have an arc length of substantially β degrees (e.g., defined within boundaries of a dashed arrow line 1022), where β=180/N (e.g., N=7, and therefore Θ=180/7=25.7 degrees).

In one or more examples, the target body of target 150 further includes one or more first arcuate apertures 1008 (e.g., here, a single first arcuate aperture defined within boundaries of a dashed arrow line 1010) between respective adjacent fin regions or fin region of one or more fin regions 1004. Respective ones of one or more first arcuate apertures 1008 (i.e., the single first arcuate aperture depicted in FIG. 10) has an arc length of substantially α degrees (e.g., 180 degrees).

In one or more examples, the target body of target 150 further includes second arcuate apertures, such as a second arcuate aperture 1026, between respective adjacent fins in the respective fin regions of one or more fin regions (i.e., the single fin region depicted in FIG. 10). Respective ones of the second arcuate apertures (e.g., second arcuate aperture 1026) have an arc length of substantially β degrees (e.g., defined within boundaries of a dashed arrow line 1024) (e.g., 25.7°).

FIG. 11 is a flowchart of a method 1100 of providing a target for an inductive angular-position sensing apparatus, according to one or more examples. More specifically, method 1100 may be utilized for designing a target pattern (e.g., a combined M and N pole pair pattern) of a target body of the target, according to one or more examples.

In one or more examples, a designed target according to method 1100 may be used in an inductive angular-position sensing apparatus including a first set of coils of a first sensor and a second set of coils of a second sensor. The first set of coils of the first sensor includes first and second sense coils, where respective ones of the first and the second sense coils have one or more M pole pairs. The second set of coils of the second sensor includes third and fourth sense coils, where respective ones of the third and the fourth sense coils have N pole pairs. The first sensor may be considered to be an M pole pair sensor and the second sensor may be considered to be an N pole pair sensor.

At an act 1102 of method 1100, a target is provided for the inductive angular-position sensing apparatus including the M pole pair sensor and the N pole pair sensor. A target pattern of the target body of the target is at least partially determined based on a logical AND (e.g., a “spatial area-wise” logical AND) of a first target design pattern for angular-position sensing using the M pole pair sensor and a second target design pattern for angular-position sensing using the N pole pair sensor.

In one or more examples, N is an integer multiple of M. In one or more other examples, N is not an integer multiple of M. In one or more examples, M=1 and N≥4.

In one or more specific examples of method 1100, a first “standard” target design pattern for angular-position sensing using the M pole pair sensor is identified (e.g., a first outlined area of its conductive material pattern) and a second “standard” target design pattern for angular-position detection using the N pole pair sensor is also identified (e.g., a second outlined area of its conductive material pattern). The first standard target design pattern may be overlaid with the second standard target design pattern (e.g., substantially aligning fin edges of fins of the first and the second target design patterns, where both patterns are provided with the same or similar sizing), or vice versa. A spatial area-wise logical AND operation of the first standard target design pattern and the second standard target design pattern may then be performed to result in a final target design pattern of the target body. The target body of the target may then be constructed in accordance with the final target pattern.

In the spatial area-wise logical AND operation, conductive areas of the standard target design patterns are the (e.g., only) areas considered to be logically true (‘1’); non-conductive areas of the target design pattern area are considered to be logically false or untrue (‘0’). Accordingly, the final target design pattern of the target body includes only conductive material pattern areas that are common to both the first and the second standard target design patterns.

In one or more examples, a first standard target design pattern (i.e., the standard M pole pair pattern) may be characterized as follows: an annular ring and one or more fins radially extending outwardly from the annular ring, where respective fins of the one or more fins have an arc length of 180/M and respective arcuate apertures between respective adjacent fins of the one or more fins have an arc length of 180/M (e.g., the respective fins of the one or more fins being equally radially spaced around the annular ring). A second standard target design pattern (i.e., the standard N pole pair pattern) may be similarly characterized as follows: an annular ring and a number of fins radially extending outwardly from the annular ring, where respective fins of the number of fins have an arc length of 180/N and respective arcuate apertures between respective adjacent fins of the number of fins have an arc length of 180/N (e.g., the respective fins being equally radially spaced around the annular ring).

FIGS. 12A, 12B, and 12C are top-down views of targets having respective target patterns to better illustrate method 1100 of FIG. 11, according to one or more examples.

More particularly, FIG. 12A is a top-down view of a first target 1202 having a first standard target pattern for inductive angular-position sensing using (only) the first sensor (e.g., M pole pair sensor, where M=1) of apparatus 100 of FIGS. 1, 2, and 3. FIG. 12B is a top-down view of a second target 1220 having a second standard target pattern for inductive angular-position sensing using (only) the second sensor (e.g., N pole pair sensor, where N=7) of apparatus 100 of FIGS. 1, 2, and 3. FIG. 12C is a top-down view of a resulting target (e.g., target 150 of FIG. 1) having a resulting (combined) target pattern configured for angular-position sensing for both the first sensor and the second sensor of apparatus 100 of FIGS. 1, 2, and 3.

In view of FIGS. 12A, 12B, and 12C, the resulting target pattern of target 150 of FIG. 12C is determined at least partially based on a spatial area-wise logical AND operation of the first standard target pattern of target 1202 of FIG. 12A and the second standard target pattern of target 1220 of FIG. 12B. The resulting (combined) target pattern of target 150 of FIG. 12C may be the target utilized in apparatus of FIGS. 1, 2, and 3 (see, e.g., target 150 of FIG. 10).

With reference back to FIG. 12A, first target 1202 includes the first standard target pattern for angular-position sensing using an M pole pair sensor, where M=1. First target 1202 includes one or more fins 1206 (e.g., a fin 1208). As M=1, first target 1202 includes (only) one (1) fin. Respective ones of one or more fins 1206 radially extend outwardly from an annular ring 1204 centered about an axis. First target 1202 includes one or more arcuate apertures 1210 between respective fins of one or more fins 1206. As M=1, first target 1202 includes (only) one (1) arcuate aperture. Respective ones of one or more fins 1206 (i.e., fin 1208) have an arc length of substantially α degrees (e.g., defined within boundaries of a dashed arrow line 1006), where α=180/M (e.g., 180/1=180 degrees). Similarly, respective ones of one or more arcuate apertures 1210 have an arc length of substantially α degrees (e.g., defined within boundaries of a dashed arrow line 1010), where α=180/M (e.g., 180/1=180 degrees).

With reference to FIG. 12B, second target 1220 includes the second standard target pattern for angular-position detection using an N pole pair sensor, where N=7. Second target 1220 includes a number of fins 1224, such as a fin 1226. As N=7, second target 1220 includes seven (7) fins. Respective ones of one or more fins 1224 radially extend outwardly from an annular ring 1222 centered about an axis. Second target 1220 includes one or more arcuate apertures 1225, such as an arcuate aperture 1228, between respective adjacent fins of the number of fins 1224. As N=7, second target 1220 includes seven (7) arcuate apertures. Respective ones of the number of fins 1224 have an arc length of substantially β degrees (e.g., defined within boundaries of a dashed arrow line 1022), where β=180/N (e.g., 180/7=25.7 degrees). Similarly, respective ones of a number of arcuate apertures 1225 have an arc length of substantially β degrees (e.g., defined within boundaries of a dashed arrow line 1024), where β=180/N (e.g., 180/7=25.7 degrees).

Accordingly, with reference to FIG. 12C, the resulting (combined) target pattern of target 150 is determined at least partially based on a spatial area-wise logical AND operation of the first standard target pattern of target 1202 of FIG. 12A and the second standard target pattern of target 1220 of FIG. 12B.

FIGS. 13A, 13B, and 13C are top-down views of alternative targets having respective target patterns to better illustrate method 1100 of FIG. 11, according to one or more examples. Again, for designing the target body, the first sensor may be considered to be an M pole pair sensor and the second sensor may be considered to be an N pole pair sensor. In the specific example of FIGS. 13A, 13B, and 13C, the first sensor is a four (4) pole pair sensor (i.e., M=4) and the second sensor is a twenty (20) pole pair sensor (i.e., N=20). Accordingly, in this specific example, M is an integer multiple of N, and the resulting target pattern (FIG. 13C) is symmetrical.

More particularly, FIG. 13A is a top-down view of a first target 1302 having a first standard target pattern for inductive angular-position sensing using (only) the first sensor, according to one or more examples. FIG. 13B is a top-down view of a second target 1320 having a second standard target pattern for inductive angular-position sensing using (only) the second sensor, according to one or more examples. FIG. 13C is a top-down view of a resulting target 1340 having a resulting (combined) target pattern configured for angular-position sensing for both the first sensor and the second sensor, according to one or more examples.

In view of FIGS. 13A, 13B, and 13C, the resulting target pattern of target 1340 of FIG. 13C is determined at least partially based on a spatial area-wise logical AND operation of the first standard target pattern of target 1302 of FIG. 13A and the second standard target pattern of target 1320 of FIG. 13B.

With reference back to FIG. 13A, first target 1302 includes the first standard target pattern for angular-position sensing using an M pole pair sensor, where M=4. First target 1302 includes one or more fins 1304, such as a fin 1306. As M=4, first target 1302 includes four (4) fins. Respective ones of one or more fins 1304 radially extend outwardly from an annular ring 1303 centered about an axis. First target 1302 includes one or more arcuate apertures 1305, such as an arcuate aperture 1308, between respective adjacent fins of one or more fins 1304. As M=4, first target 1302 includes four (4) arcuate apertures. Respective ones of one or more fins 1304 have an arc length of substantially α degrees (e.g., defined within boundaries of a dashed arrow line 1310), where α=180/M (e.g., 180/4=45 degrees). Similarly, respective ones of one or more apertures 1305 have an arc length of substantially α degrees (e.g., defined within boundaries of a dashed arrow line 1312), where α=180/M (e.g., 180/4=45 degrees).

With reference to FIG. 13B, second target 1320 includes the second standard target pattern for angular-position sensing using an N pole pair sensor, where N=20. Second target 1320 includes a number of fins 1322 (e.g., a fin 1324). As N=20, second target 1320 includes twenty (20) fins. Respective ones of the number of fins 1322 radially extend outwardly from an annular ring 1321 centered about an axis. Second target 1320 includes a number of arcuate apertures 1323, such as an arcuate aperture 1326, between respective adjacent fins of the number of fins 1322. As N=20, second target 1320 includes twenty (20) arcuate apertures. Respective ones of the number of fins 1322 have an arc length of substantially β degrees (e.g., defined within boundaries of a dashed arrow line 1328), where β=180/N (e.g., here, N=20, and therefore β=180/20=9 degrees). Similarly, respective ones of the number of arcuate apertures 1323 have an arc length of substantially β degrees (e.g., defined within boundaries of a dashed arrow line 1330), where β=180/N (e.g., 180/20=9 degrees).

Accordingly, with reference to FIG. 13C, the resulting (combined) target pattern of target 1340 is determined at least partially based on a spatial area-wise logical AND operation of the first standard target pattern of target 1302 of FIG. 13A and the second standard target pattern of target 1320 of FIG. 13B.

Here, target 1340 of FIG. 13C has a target pattern for angular-position sensing using both an M pole pair sensor and an N pole pair sensor, where M=4 and N=20. Target 1340 includes one or more fin regions 1342. Respective ones of one or more fin regions 1342 include a number of fins, such as a fin 1345, radially extending outwardly from an annular ring 1341 centered about an axis. Target 1340 includes one or more first arcuate apertures 1343, such as a first arcuate aperture 1346, between respective adjacent fins of one or more fin regions 1342. Respective ones of one or more fin regions 1342 have an arc length of substantially α degrees (e.g., defined within boundaries of a dashed arrow line 1344), where α=180/M (e.g., α=180/4=45 degrees). Similarly, respective ones of one or more first arcuate apertures 1343 have an arc length of substantially α degrees (e.g., defined within boundaries of a dashed arrow line 1346), where α=180/M (e.g., α=180/4=45 degrees). Respective ones of the number of fins (e.g., fin 1345) in a respective fin region have an arc length of substantially β degrees, where β=180/N (e.g., 180/20=9 degrees). Target 1340 also includes second arcuate apertures, such as a second aperture 1347, between respective adjacent fins (e.g., fin 1345) in a respective fin region. Respective ones of second arcuate apertures (e.g., second aperture 1347) have an arc length of substantially β degrees (e.g., 180/20=9 degrees).

FIGS. 14A, 14B, and 14C are top-down views of additional alternative targets having respective target patterns to further illustrate the method of FIG. 11, according to one or more examples. Again, for designing the target body, the first sensor may be considered to be an M pole pair sensor and the second sensor may be considered to be an N pole pair sensor. In the specific example of FIGS. 14A, 14B, and 14C, the first sensor is a three (3) pole pair sensor (i.e., M=3) and the second sensor is a five (5) pole pair sensor (i.e., N=5). Accordingly, in this specific example, M is not an integer multiple of N, and the resulting target pattern (FIG. 14C) is non-symmetrical.

More particularly, FIG. 14A is a top-down view of a first target 1402 having a first standard target pattern for inductive angular-position sensing using (only) the first sensor, according to one or more examples. FIG. 14B is a top-down view of a second target 1420 having a second standard target pattern for inductive angular-position sensing using (only) the second sensor, according to one or more examples. FIG. 14C is a top-down view of a resulting target 1440 having a resulting (combined) target pattern configured for angular-position sensing for both the first sensor and the second sensor, according to one or more examples.

In view of FIGS. 14A, 14B, and 14C, the resulting target pattern of target 1440 of FIG. 14C is determined at least partially based on a spatial arca-wise logical AND operation of the first standard target pattern of target 1402 of FIG. 14A and the second standard target pattern of target 1420 of FIG. 14B.

With reference back to FIG. 14A, first target 1402 includes the first standard target pattern for angular-position sensing using an M pole pair sensor, where M=3. First target 1402 includes one or more fins 1404, such as a fin 1406. As M=3, first target 1402 includes three (3) fins. Respective ones of one or more fins 1404 radially extend outwardly from an annular ring 1403 centered about an axis. First target 1402 includes one or more arcuate apertures 1405 between respective adjacent fins of one or more fins 1404. As M=3, first target 1402 includes three (3) arcuate apertures. Respective ones of one or more fins 1404 have an arc length of substantially α degrees (e.g., defined within boundaries of a dashed arrow line 1410), where α=180/M (e.g., 180/3=60 degrees). Similarly, respective ones of one or more arcuate apertures 1405 have an arc length of substantially α degrees (e.g., defined within boundaries of a dashed arrow line 1412), where α=180/M (e.g., 180/3=60 degrees).

With reference to FIG. 14B, second target 1420 includes the second standard target pattern for angular-position sensing using an N pole pair sensor, where N=5. Second target 1420 includes a number of fins 1422 (e.g., a fin 1424). As N=5, second target 1420 includes five (5) fins. Respective ones of the number of fins 1422 radially extend outwardly from an annular ring 1421 centered about an axis. Second target 1420 includes a number of arcuate apertures 1423 between respective adjacent fins of the number of fins 1422. As N=5, second target 1420 includes five (5) arcuate apertures. Respective ones of the number of fins 1422 (e.g., fin 1424) have an arc length of substantially β degrees (e.g., defined within boundaries of a dashed arrow line 1428), where β=180/N (e.g., here, N=5, and therefore β=180/5=36 degrees). Similarly, respective ones of the number of arcuate apertures 1423 have an arc length of substantially β degrees (e.g., defined within boundaries of a dashed arrow line 1440), where β=180/N (e.g., 180/5=36 degrees).

Accordingly, with reference to FIG. 14C, the resulting (combined) target pattern of target 1440 is determined at least partially based on a spatial arca-wise logical AND operation of the first standard target pattern of target 1402 of FIG. 14A and the second standard target pattern of target 1420 of FIG. 14B.

Here, target 1440 of FIG. 14C has a target pattern for angular-position sensing using both an M pole pair sensor and an N pole pair sensor, where M=3 and N=5. Target 1440 includes one or more fin regions 1442. Respective ones of one or more fin regions 1442 include a number of fins, such as a fin 1445, radially extending outwardly from an annular ring 1441 centered about an axis. Target 1440 includes one or more first arcuate apertures 1443 between respective adjacent fins of one or more fin regions 1442. Respective ones of one or more fin regions 1442 have an arc length of substantially α degrees, where α=180/M (e.g., α=180/3=60 degrees). Similarly, respective ones of one or more first arcuate apertures 1443 have an arc length of at least substantially α degrees (e.g., defined within boundaries of a dashed arrow line 1446), where α=180/M (e.g., α=180/3=60 degrees). Respective ones of at least some of the fins (e.g., fin 1445) in a respective fin region have an arc length of substantially β degrees, where β=180/N (e.g., 180/5=36 degrees). Other respective ones of some of the fins in a respective fin region have an arc length of substantially half of the difference between α and β (i.e., ½ of (α−β), or e.g., ½ of (60−36)=12 degrees), as shown.

With respect to the designed target patterns, it is noted that each secondary winding has both positive and negative lobes, portions of which are covered by the target pattern for disturbance of the magnetic field (e.g., resulting in non-zero output voltage). In sensor designs having the different pole pairs in the secondary windings, it is desirable that the target that covers should be of the same polarity in multi-pole designs and should apply to the two different pole pairs of the sensor design. When M is an integer multiple of N (e.g., symmetrical target pattern), the target always covers the positive and the negative lobes at a given instant with respect to target movement. When M is not an integer multiple of N, the target pattern is designed as an asymmetrical pattern to cover the positive and the negative lobes at a given instant.

Thus, as described in various examples, the first set of coils, the second set of coils, and/or the target pattern of the target body of the target of the inductive angular-position sensing apparatus may be configured to accommodate any suitable combination of M and N, where M and N are positive integers, and N is greater than M.

Some examples of the disclosure have been described in relation to an apparatus including multiple sensors and/or target patterns having a combination of one (1) pole pair and seven (7) pole pairs. In such advantageous examples, an inductive angular-position sensing apparatus is adapted to detect an index of the target (e.g., a coarse measurement) as well as a high resolution measurement. Other different pole pair combinations have also been described.

However, examples of the disclosure are not limited to sensing apparatuses having certain numbered combinations of pole pairs. In one or more examples, an apparatus including multiple sensors and/or target patterns having differently numbered combinations of pole pairs may be employed. In one or more examples, an inductive angular-position sensing apparatus may include various numbered combinations of a one pole pair sensor, a two pole pair sensor, a three pole pair sensor, a five pole pair sensor, a six pole pair sensor, a ten pole pair sensor, a twenty pole pair sensor, and so on, without limitation.

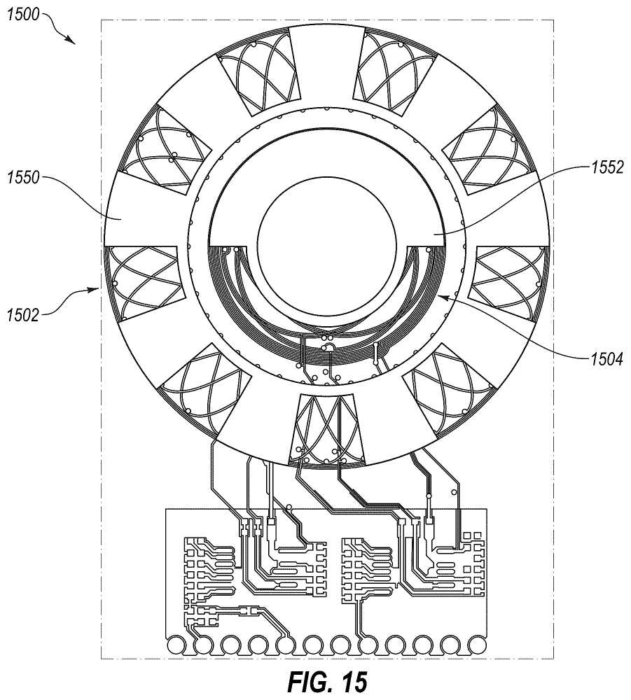

FIG. 15 is a top-down view of an apparatus 1500 for inductive angular-position sensing that is known by the inventors of this disclosure. Apparatus 1500 includes first coils 1502 of a first sensor to sense an angular-position of a first target 1550 (all contained within an outer annulus) and second coils 1504 of a second sensor to sense an angular-position of a second target 1552 (all contained within an inner annulus, separate from and non-overlapping with the outer annulus). As depicted, the first sensor using first target 1550 may be a nine (9) pole pair sensor of the second sensor using second target 1552 may be a one (1) pole pair sensor. Such a type of apparatus 1500 for inductive angular-position sensing is described in U.S. Pat. No. 11,598,654. Such a type of apparatus 1500 may require the use of two separate target body shapes in respective outer and inner annuluses as depicted, instead of a single-bodied target within the same annulus of the sets of coils according to one or more examples of this disclosure. Such a type of apparatus 1500 may occupy more space than one or more examples of this disclosure.

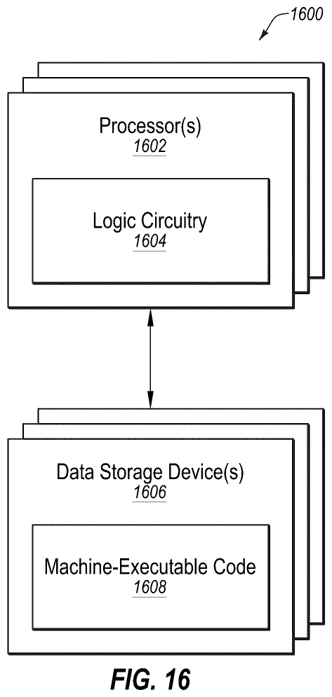

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 16 illustrates non-limiting examples of implementations of functional elements disclosed herein. In some examples, some or all portions of the functional elements disclosed herein may be performed by hardware specially implemented for carrying out the functional elements.

FIG. 16 is a block diagram of circuitry 1600 that, in some examples, may be used to implement various functions, operations, acts, processes, and/or methods disclosed herein. In one or more examples, circuitry 1600 may be part of a computing device of a computing system. Circuitry 1600 includes one or more processors 1602 (sometimes referred to herein as “processor 1602”) operably coupled to one or more data storage devices (sometimes referred to herein as “storage 1606”). Storage 1606 includes machine-executable code 1608 stored thereon and processor 1602 include a logic circuitry 1604. Machine-executable code 1608 includes information describing functional elements that may be implemented by (e.g., performed by) logic circuitry 1604. Logic circuitry 1604 is adapted to implement (e.g., perform) the functional elements described by machine-executable code 1608. Circuitry 1600, when executing the functional elements described by machine-executable code 1608, should be considered as special purpose hardware for carrying out functional elements disclosed herein. In some examples, processor 1602 may perform the functional elements described by machine-executable code 1608 sequentially, concurrently (e.g., on one or more different hardware platforms), or in one or more parallel process streams.

When implemented by logic circuitry 1604 of processor 1602, machine-executable code 1608 adapts processor 1602 to perform operations of examples disclosed herein. For example, machine-executable code 1608 may adapt processor 1602 to perform at least a portion or a totality of the methods or processes described herein. In one or more examples, machine-executable code 1608 may adapt processor 1602 to perform at least a portion or a totality of the methods or processes associated with the methodologies described in relation to method 700 of FIG. 7 (e.g., act 710 of FIG. 7), method 800 of FIG. 8, and/or other functionalities in the CPUs of sensor IC 601 of FIG. 6 for position sensing circuitry 110 and 112 of FIGS. 1, 2, and 3.

Processor 1602 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1608 (e.g., software code, firmware code, hardware descriptions) related to examples of the present disclosure. It is noted that a general-purpose processor (may also be referred to herein as a host processor or simply a host) may be a microprocessor, but in the alternative, processor 1602 may include any conventional processor, controller, microcontroller, or state machine. Processor 1602 may also be implemented as a combination of computing devices, such as a combination of a DSP and a microprocessor, a plurality of microprocessors, one or more microprocessors in conjunction with a DSP core, or any other such configuration.

In some examples, storage 1606 includes volatile data storage (e.g., random-access memory (RAM)), non-volatile data storage (e.g., Flash memory, a hard disc drive, a solid state drive, erasable programmable read-only memory (EPROM), etc.). In some examples, processor 1602 and storage 1606 may be implemented into a single device (e.g., a semiconductor device product, a system on chip (SoC), etc.). In some examples, processor 1602 and storage 1606 may be implemented into separate devices.

In some examples, machine-executable code 1608 may include computer-readable instructions (e.g., software code, firmware code). By way of non-limiting example, the computer-readable instructions may be stored by storage 1606, accessed directly by processor 1602, and executed by processor 1602 using at least logic circuitry 1604. Also by way of non-limiting example, the computer-readable instructions may be stored on storage 1606, transferred to a memory device (not shown) for execution, and executed by processor 1602 using at least logic circuitry 1604. Accordingly, in some examples, logic circuitry 1604 includes electrically configurable logic circuitry 1604.

In some examples, machine-executable code 1608 may describe hardware (e.g., circuitry) to be implemented in logic circuitry 1604 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog, or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 1604 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1608 may include an HDL, an RTL, a GL description, a mask level description, other hardware description, or any combination thereof.

In examples where machine-executable code 1608 includes a hardware description (at any level of abstraction), a system (not shown, but including storage 1606) may implement the hardware description described by machine-executable code 1608. By way of non-limiting example, processor 1602 may include a programmable logic device (e.g., an FPGA or a PLC) and logic circuitry 1604 may be electrically controlled to implement circuitry corresponding to the hardware description into logic circuitry 1604. Also by way of non-limiting example, logic circuitry 1604 may include hard-wired logic manufactured by a manufacturing system (not shown, but including storage 1606) according to the hardware description of machine-executable code 1608.

Regardless of whether machine-executable code 1608 includes computer-readable instructions or a hardware description, logic circuitry 1604 is adapted to perform the functional elements described by machine-executable code 1608 when implementing the functional elements of machine-executable code 1608. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Note that each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Additional non-limiting examples of the disclosure include:

Example 1: An apparatus comprising: a support structure; a first set of coils on, or in, the support structure, the first set of coils arranged within an annulus centered about an axis, the first set of coils including a first sense coil and a second sense coil, respective ones of the first sense coil and the second sense coil having one or more M pole pairs, where M is a positive integer; a second set of coils on, or in, the support structure, the second set of coils arranged within the annulus, the second set of coils including a third sense coil and a fourth sense coil, respective ones of the third sense coil and the fourth sense coil having N pole pairs, where N is a positive integer greater than M; and a target to rotate about the axis, the target having a target body comprising an annular ring and one or more fin regions, respective fin regions of the one or more fin regions including a number of fins radially extending outwardly from the annular ring.

Example 2: The apparatus according to Example 1, wherein: the one or more fin regions define an M pole pair pattern, and the number of fins in the respective fin regions of the one or more fin regions define an N pole pair pattern.

Example 3: The apparatus according to any of Examples 1 and 2, wherein: the respective fin regions of the one or more fin regions have an arc length of substantially α degrees, where α=180/M, and respective fins of the number of fins in the respective fin regions have an arc length of substantially β degrees, where β=180/N.

Example 4: The apparatus according to any of Examples 1 through 3, wherein the target body includes: one or more first arcuate apertures between respective adjacent fin regions or fin region of the one or more fin regions, respective ones of the one or more first arcuate apertures having an arc length of substantially α degrees, and second arcuate apertures between respective adjacent fins of the number of fins in the respective fin regions, respective ones of the second arcuate apertures having an arc length of substantially β degrees.

Example 5: The apparatus according to any of Examples 1 through 4, wherein: the first set of coils comprise one or more first oscillator coils on, or in, the support structure, the one or more first oscillator coils arranged in a circular pattern as or along an outer boundary of the annulus, and the second set of coils comprise one or more second oscillator coils on, or in, the support structure, the one or more second oscillator coils arranged in the circular pattern as or along the outer boundary of the annulus.

Example 6: The apparatus according to any of Examples 1 through 5, comprising: a first position sensing circuitry to: generate an excitation signal in one or more first oscillator coils to produce a varying magnetic field to induce first and second sense signals in the first and the second sense coils, respectively, the varying magnetic field disturbed in accordance with an angular-position of the target which modulates the first and the second sense signals to produce modulated first and second sense signals, respectively, according to the M pole pair pattern; receive the modulated first and second sense signals from the first and the second sense coils, respectively; and demodulate the modulated first and second sense signals to produce demodulated first and second position signals, respectively, wherein respective ones of the demodulated first and second position signals exhibit one or more M cycles for every full rotation of the target.

Example 7: The apparatus according to any of Examples 1 through 6, comprising: a second position sensing circuitry to: generate an excitation signal in one or more second oscillator coils to produce a varying magnetic field to induce third and fourth sense signals in the third and the fourth sense coils, respectively, the varying magnetic field disturbed in accordance with the angular-position of the target which modulates the third and the fourth sense signals to produce modulated third and fourth sense signals, respectively, according to the N pole pair pattern; receive the modulated third and fourth sense signals from the third and the fourth sense coils, respectively; and demodulate the modulated third and the fourth sense signals to produce demodulated third and fourth position signals, respectively, wherein respective ones of the demodulated third and fourth position signals exhibit N cycles for every full rotation of the target.

Example 8: The apparatus according to any of Examples 1 through 7, wherein: the first position sensing circuitry is to calculate a first angular-position of the target at least partially based on the demodulated first and second position signals, and the second position sensing circuitry is to calculate a second angular-position of the target at least partially based on the demodulated third and fourth position signals.

Example 9: The apparatus according to any of Examples 1 through 8, wherein: the calculated first angular-position comprises a coarse resolution measurement of the angular-position of the target, and the calculated second angular-position comprises a fine resolution measurement of the angular-position of the target.

Example 10: The apparatus according to any of Examples 1 through 9, wherein the target is to rotate about the axis with the target body generally over the first and the second sets of coils and coextensive with the annulus, and M=1.

Example 11: The apparatus according to any of Examples 1 through 10, wherein N=7.

Example 12: A method comprising: at an inductive angular-position sensing apparatus including a rotatable target, the rotatable target including a target body having a combined M and N pole pair pattern, the combined M and N pole pair pattern comprising a combination of an M pole pair pattern and an N pole pair pattern, where M and N are integer numbers and N>M, sensing or detecting a first angular-position of the rotatable target at least partially based on modulated first and second sense signals from first and second sense coils, respectively, the modulated first and second sense signals being modulated according to the M pole pair pattern of the rotatable target, respective ones of the first and the second sense coils having one or more M pole pairs; and sensing or detecting a second angular-position of the rotatable target at least partially based on modulated third and fourth sense signals from third and fourth sense coils, respectively, the modulated third and fourth sense signals being modulated according to the N pole pair pattern of the rotatable target, respective ones of the third and the fourth sense coils having N pole pairs.

Example 13: The method according to Example 12, wherein: sensing or detecting the first angular-position of the rotatable target comprises sensing or detecting the first angular-position having a first measurement resolution, and sensing or detecting the second angular-position of the rotatable target comprises sensing or detecting the second angular-position having a second measurement resolution, the second measurement resolution different from the first measurement resolution.

Example 14: The method according to any of Examples 12 and 13, wherein: sensing or detecting the first angular-position of the rotatable target includes producing demodulated first and second position signals at least partially based on the modulated first and second sense signals, respective ones of the demodulated first and second position signals exhibiting one or more M cycles for every full rotation of the rotatable target, and sensing or detecting the second angular-position of the rotatable target includes producing demodulated third and fourth position signals at least partially based on the modulated third and fourth sense signals, respective ones of the demodulated third and fourth position signals exhibiting N cycles for every full rotation of the rotatable target.

Example 15: The method according to any of Examples 12 through 14, wherein the target body comprises an annular ring and one or more fin regions, respective fin regions of the one or more fin regions including a number of fins radially extending outwardly from the annular ring, the one or more fin regions defining the M pole pair pattern, the number of fins in the respective fin regions of the one or more fin regions defining the N pole pair pattern.

Example 16: The method according to any of Examples 12 through 15, wherein the respective fin regions of the one or more fin regions have an arc length of substantially α degrees, where α=180/M, respective fins of the number of fins in the respective fin regions having an arc length of substantially β degrees, where β=180/N.

Example 17: The method according to any of Examples 12 through 16, wherein the target body has one or more first arcuate apertures between respective adjacent fin regions or fin region of the one or more fin regions, respective ones of the one or more first arcuate apertures having an arc length of substantially α degrees, the target body having second arcuate apertures between respective adjacent fins of the number of fins in the respective fin regions, respective ones of the second arcuate apertures having an arc length of substantially β degrees.

Example 18: The method according to any of Examples 12 through 17, wherein the target pattern of the target body is at least partially based on a spatial area-wise logical AND of a first standard target design pattern and a second standard target design pattern, the first standard target design pattern for angular-position sensing using an M pole pair sensor, the second standard target design pattern for angular-position sensing using an N pole pair sensor.

Example 19: An apparatus comprising: a target including a target body, the target body comprising: an annular ring; one or more fin regions, respective fin regions of the one or more fin regions including a number of fins radially extending outwardly from the annular ring; the one or more fin regions defining an M pole pair pattern, where M is a positive integer; and the number of fins in the respective fin regions of the one or more fin regions defining an N pole pair pattern, where N is a positive integer greater than M.

Example 20: The apparatus according to Example 19, wherein M is an integer multiple of N, and wherein: the respective fin regions of the one or more fin regions have an arc length of substantially α degrees, where α=180/M, and respective fins of the number of fins in the respective fin regions of the one or more fin regions have an arc length of substantially β degrees, where β=180/N.

Example 21: The apparatus according to any of Examples 19 and 20, wherein the target body comprises: one or more first arcuate apertures between respective adjacent fin regions or fin region of the one or more fin regions, respective ones of the one or more first arcuate apertures having an arc length of substantially α degrees; and second arcuate apertures between respective adjacent fins in the respective fin regions of the one or more fin regions, respective ones of the second arcuate apertures having an arc length of substantially β degrees.

Example 22: The apparatus according to any of Examples 19 through 21, comprising: an inductive angular-position sensing apparatus including the target, the inductive angular-position sensing apparatus to detect a first angular-position of the target at least partially according to the M pole pair pattern, the inductive angular-position sensing apparatus to detect a second angular-position of the target at least partially according to the N pole pair pattern.

Example 23: A method comprising: at an inductive angular-position sensing apparatus adapted to sense or detect an angular-position of a rotatable target, the rotatable target including a target body having a combined M and N pole pair pattern, the combined M and N pole pair pattern comprising a combination of an M pole pair pattern and an N pole pair pattern, where M and N are integer numbers and N>M, generating an excitation signal in one or more first oscillator coils of the inductive angular-position sensing apparatus to produce a varying magnetic field to induce first and second sense signals in first and second sense coils, respectively, of the inductive angular-position sensing apparatus, the varying magnetic field disturbed in accordance with the angular-position of the rotatable target which modulates the first and the second sense signals to produce modulated first and second sense signals, respectively, according to the M pole pair pattern; receiving the modulated first and second sense signals from the first and the second sense coils, respectively; and demodulating the modulated first and second sense signals to produce demodulated first and second position signals, respectively, wherein respective ones of the demodulated first and second position signals exhibit one or more M cycles for every full rotation of the rotatable target.

Example 24: The method according to Example 23, comprising: at the inductive angular-position sensing apparatus, generating an excitation signal in one or more second oscillator coils of the inductive angular-position sensing apparatus to produce a varying magnetic field to induce third and fourth sense signals in third and fourth sense coils, respectively, of the inductive angular-position sensing apparatus, the varying magnetic field disturbed in accordance with the angular-position of the rotatable target which modulates the third and the fourth sense signals to produce modulated third and fourth sense signals, respectively, according to the N pole pair pattern; receiving the modulated third and fourth sense signals from the third and the fourth sense coils, respectively; and demodulating the modulated third and fourth sense signals to produce demodulated third and fourth position signals, respectively; wherein respective ones of the demodulated third and fourth position signals exhibit N cycles for every full rotation of the rotatable target.

Example 25: The method according to any of Examples 23 and 24, comprising: at the inductive angular-position sensing apparatus, calculating a first angular-position of the target at least partially based on the demodulated first and second position signals; and calculating a second angular-position of the target at least partially based on the demodulated third and fourth position signals.

Example 26: The method according to any of Examples 23 through 25, wherein the rotatable target comprises an annular ring and one or more fin regions, respective fin regions of the one or more fin regions including a number of fins radially extending outwardly from the annular ring, the one or more fin regions defining the M pole pair pattern, the number of fins in the respective fin regions of the one or more fin regions defining the N pole pair pattern.

Example 27: The method according to any of Examples 23 through 26, wherein the respective fin regions of the one or more fin regions having an arc length of substantially α degrees, where α=180/M, respective fins of the number of fins in the respective fin regions having an arc length of substantially β degrees, where β=180/N.

Example 28: The method according to any of Examples 23 through 27, wherein the target body has one or more first arcuate apertures between respective adjacent fin regions or fin region of the one or more fin regions, respective ones of the one or more first arcuate apertures having an arc length of substantially α degrees, the target body having second arcuate apertures between respective adjacent fins of the number of fins in the respective fin regions, respective ones of the second arcuate apertures having an arc length of substantially β degrees.

Example 29: An apparatus comprising: a support structure; a first set of coils on, or in, the support structure, the first set of coils arranged within an annulus centered about an axis, the first set of coils including a first sense coil and a second sense coil, respective ones of the first sense coil and the second sense coil having one or more M pole pairs; a second set of coils on, or in, the support structure, the second set of coils arranged within the annulus, the second set of coils including a third sense coil and a fourth sense coil, respective ones of the third sense coil and the fourth sense coil having N pole pairs; and a target to rotate about the axis, the target including a target body having a combined M and N target pattern, the combined M and N target pattern comprising a combination of an M pole pair pattern and an N pole pair pattern, where M and N are positive integers and N>M.

Example 30: The apparatus according to Example 29, wherein the target pattern of the target body is at least partially based on a spatial area-wise logical AND of a first standard target design pattern and a second standard target design pattern, the first standard target design pattern for angular-position sensing using an M pole pair sensor, the second standard target design pattern for angular-position sensing using an N pole pair sensor.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a support structure;
a first set of coils on, or in, the support structure, the first set of coils arranged within an annulus centered about an axis, the first set of coils including a first sense coil and a second sense coil, respective ones of the first sense coil and the second sense coil having one or more M pole pairs, where M is a positive integer;
a second set of coils on, or in, the support structure, the second set of coils arranged within the annulus, the second set of coils including a third sense coil and a fourth sense coil, respective ones of the third sense coil and the fourth sense coil having N pole pairs, where N is a positive integer greater than M; and
a target to rotate about the axis, the target having a target body comprising an annular ring and one or more fin regions, respective fin regions of the one or more fin regions including a number of fins radially extending outwardly from the annular ring.

2. The apparatus of claim 1, wherein:
the one or more fin regions define an M pole pair pattern, and
the number of fins in the respective fin regions of the one or more fin regions define an N pole pair pattern.

3. The apparatus of claim 2, wherein:
the respective fin regions of the one or more fin regions have an arc length of substantially α degrees, where α=180/M, and
respective fins of the number of fins in the respective fin regions have an arc length of substantially β degrees, where β=180/N.

4. The apparatus of claim 3, wherein the target body includes:
one or more first arcuate apertures between respective adjacent fin regions or fin region of the one or more fin regions, respective ones of the one or more first arcuate apertures having an arc length of substantially α degrees, and
second arcuate apertures between respective adjacent fins of the number of fins in the respective fin regions, respective ones of the second arcuate apertures having an arc length of substantially β degrees.

5. The apparatus of claim 1, wherein:
the first set of coils comprise one or more first oscillator coils on, or in, the support structure, the one or more first oscillator coils arranged in a circular pattern as or along an outer boundary of the annulus, and
the second set of coils comprise one or more second oscillator coils on, or in, the support structure, the one or more second oscillator coils arranged in the circular pattern as or along the outer boundary of the annulus.

6. The apparatus of claim 2, comprising:
a first position sensing circuitry to:
generate an excitation signal in one or more first oscillator coils to produce a varying magnetic field to induce first and second sense signals in the first and the second sense coils, respectively, the varying magnetic field disturbed in accordance with an angular-position of the target which modulates the first and the second sense signals to produce modulated first and second sense signals, respectively, according to the M pole pair pattern;
receive the modulated first and second sense signals from the first and the second sense coils, respectively; and
demodulate the modulated first and second sense signals to produce demodulated first and second position signals, respectively,
wherein respective ones of the demodulated first and second position signals exhibit one or more M cycles for every full rotation of the target.

7. The apparatus of claim 6, comprising:
a second position sensing circuitry to:
generate an excitation signal in one or more second oscillator coils to produce a varying magnetic field to induce third and fourth sense signals in the third and the fourth sense coils, respectively, the varying magnetic field disturbed in accordance with the angular-position of the target which modulates the third and the fourth sense signals to produce modulated third and fourth sense signals, respectively, according to the N pole pair pattern;
receive the modulated third and fourth sense signals from the third and the fourth sense coils, respectively; and
demodulate the modulated third and the fourth sense signals to produce demodulated third and fourth position signals, respectively,
wherein respective ones of the demodulated third and fourth position signals exhibit N cycles for every full rotation of the target.

8. The apparatus of claim 7, wherein:
the first position sensing circuitry is to calculate a first angular-position of the target at least partially based on the demodulated first and second position signals, and
the second position sensing circuitry is to calculate a second angular-position of the target at least partially based on the demodulated third and fourth position signals.

9. The apparatus of claim 8, wherein:
the calculated first angular-position comprises a coarse resolution measurement of the angular-position of the target, and
the calculated second angular-position comprises a fine resolution measurement of the angular-position of the target.

10. The apparatus of claim 2, wherein the target is to rotate about the axis with the target body generally over the first and the second sets of coils and coextensive with the annulus, and M=1.

11. The apparatus of claim 10, wherein N=7.

12. A method comprising:
at an inductive angular-position sensing apparatus including a rotatable target, the rotatable target including a target body having a combined M and N pole pair pattern, the combined M and N pole pair pattern comprising a combination of an M pole pair pattern and an N pole pair pattern, where M and N are integer numbers and N>M,
sensing or detecting a first angular-position of the rotatable target at least partially based on modulated first and second sense signals from first and second sense coils, respectively, the modulated first and second sense signals being modulated according to the M pole pair pattern of the rotatable target, respective ones of the first and the second sense coils having one or more M pole pairs; and
sensing or detecting a second angular-position of the rotatable target at least partially based on modulated third and fourth sense signals from third and fourth sense coils, respectively, the modulated third and fourth sense signals being modulated according to the N pole pair pattern of the rotatable target, respective ones of the third and the fourth sense coils having N pole pairs.

13. The method of claim 12, wherein:
sensing or detecting the first angular-position of the rotatable target comprises sensing or detecting the first angular-position having a first measurement resolution, and
sensing or detecting the second angular-position of the rotatable target comprises sensing or detecting the second angular-position having a second measurement resolution, the second measurement resolution different from the first measurement resolution.

14. The method of claim 12, wherein:
sensing or detecting the first angular-position of the rotatable target includes producing demodulated first and second position signals at least partially based on the modulated first and second sense signals, respective ones of the demodulated first and second position signals exhibiting one or more M cycles for every full rotation of the rotatable target, and
sensing or detecting the second angular-position of the rotatable target includes producing demodulated third and fourth position signals at least partially based on the modulated third and fourth sense signals, respective ones of the demodulated third and fourth position signals exhibiting N cycles for every full rotation of the rotatable target.

15. The method of claim 12, wherein the target body comprises an annular ring and one or more fin regions, respective fin regions of the one or more fin regions including a number of fins radially extending outwardly from the annular ring, the one or more fin regions defining the M pole pair pattern, the number of fins in the respective fin regions of the one or more fin regions defining the N pole pair pattern.

16. The method of claim 15, wherein the respective fin regions of the one or more fin regions have an arc length of substantially α degrees, where α=180/M, respective fins of the number of fins in the respective fin regions having an arc length of substantially β degrees, where β=180/N.

17. The method of claim 16, wherein the target body has one or more first arcuate apertures between respective adjacent fin regions or fin region of the one or more fin regions, respective ones of the one or more first arcuate apertures having an arc length of substantially α degrees, the target body having second arcuate apertures between respective adjacent fins of the number of fins in the respective fin regions, respective ones of the second arcuate apertures having an arc length of substantially β degrees.

18. The method of claim 12, wherein the target pattern of the target body is at least partially based on a spatial area-wise logical AND of a first standard target design pattern and a second standard target design pattern, the first standard target design pattern for angular-position sensing using an M pole pair sensor, the second standard target design pattern for angular-position sensing using an N pole pair sensor.

19. An apparatus comprising:
a target including a target body, the target body comprising:
an annular ring;
one or more fin regions, respective fin regions of the one or more fin regions including a number of fins radially extending outwardly from the annular ring;
the one or more fin regions defining an M pole pair pattern, where M is a positive integer; and
the number of fins in the respective fin regions of the one or more fin regions defining an N pole pair pattern, where N is a positive integer greater than M.

20. The apparatus of claim 19, wherein M is an integer multiple of N, and wherein:
the respective fin regions of the one or more fin regions have an arc length of substantially α degrees, where α=180/M, and
respective fins of the number of fins in the respective fin regions of the one or more fin regions have an arc length of substantially β degrees, where β=180/N.

21. The apparatus of claim 20, wherein the target body comprises:
one or more first arcuate apertures between respective adjacent fin regions or fin region of the one or more fin regions, respective ones of the one or more first arcuate apertures having an arc length of substantially α degrees; and
second arcuate apertures between respective adjacent fins in the respective fin regions of the one or more fin regions, respective ones of the second arcuate apertures having an arc length of substantially β degrees.

22. The apparatus of claim 19, comprising:
an inductive angular-position sensing apparatus including the target, the inductive angular-position sensing apparatus to detect a first angular-position of the target at least partially according to the M pole pair pattern, the inductive angular-position sensing apparatus to detect a second angular-position of the target at least partially according to the N pole pair pattern.

23. A method comprising:
at an inductive angular-position sensing apparatus adapted to sense or detect an angular-position of a rotatable target, the rotatable target including a target body having a combined M and N pole pair pattern, the combined M and N pole pair pattern comprising a combination of an M pole pair pattern and an N pole pair pattern, where M and N are integer numbers and N>M,
generating an excitation signal in one or more first oscillator coils of the inductive angular-position sensing apparatus to produce a varying magnetic field to induce first and second sense signals in first and second sense coils, respectively, of the inductive angular-position sensing apparatus, the varying magnetic field disturbed in accordance with the angular-position of the rotatable target which modulates the first and the second sense signals to produce modulated first and second sense signals, respectively, according to the M pole pair pattern;
receiving the modulated first and second sense signals from the first and the second sense coils, respectively; and
demodulating the modulated first and second sense signals to produce demodulated first and second position signals, respectively,
wherein respective ones of the demodulated first and second position signals exhibit one or more M cycles for every full rotation of the rotatable target.

24. The method of claim 23, comprising:
at the inductive angular-position sensing apparatus,
generating an excitation signal in one or more second oscillator coils of the inductive angular-position sensing apparatus to produce a varying magnetic field to induce third and fourth sense signals in third and fourth sense coils, respectively, of the inductive angular-position sensing apparatus, the varying magnetic field disturbed in accordance with the angular-position of the rotatable target which modulates the third and the fourth sense signals to produce modulated third and fourth sense signals, respectively, according to the N pole pair pattern;
receiving the modulated third and fourth sense signals from the third and the fourth sense coils, respectively; and
demodulating the modulated third and fourth sense signals to produce demodulated third and fourth position signals, respectively;
wherein respective ones of the demodulated third and fourth position signals exhibit N cycles for every full rotation of the rotatable target.

25. The method of claim 24, comprising:
at the inductive angular-position sensing apparatus,
calculating a first angular-position of the target at least partially based on the demodulated first and second position signals; and
calculating a second angular-position of the target at least partially based on the demodulated third and fourth position signals.

26. The method of claim 24, wherein the rotatable target comprises an annular ring and one or more fin regions, respective fin regions of the one or more fin regions including a number of fins radially extending outwardly from the annular ring, the one or more fin regions defining the M pole pair pattern, the number of fins in the respective fin regions of the one or more fin regions defining the N pole pair pattern.

27. The method of claim 26, wherein the respective fin regions of the one or more fin regions having an arc length of substantially α degrees, where α=180/M, respective fins of the number of fins in the respective fin regions having an arc length of substantially β degrees, where β=180/N.

28. The method of claim 27, wherein the target body has one or more first arcuate apertures between respective adjacent fin regions or fin region of the one or more fin regions, respective ones of the one or more first arcuate apertures having an arc length of substantially α degrees, the target body having second arcuate apertures between respective adjacent fins of the number of fins in the respective fin regions, respective ones of the second arcuate apertures having an arc length of substantially β degrees.

29. An apparatus comprising:
a support structure;
a first set of coils on, or in, the support structure, the first set of coils arranged within an annulus centered about an axis, the first set of coils including a first sense coil and a second sense coil, respective ones of the first sense coil and the second sense coil having one or more M pole pairs;
a second set of coils on, or in, the support structure, the second set of coils arranged within the annulus, the second set of coils including a third sense coil and a fourth sense coil, respective ones of the third sense coil and the fourth sense coil having N pole pairs; and
a target to rotate about the axis, the target including a target body having a combined M and N target pattern, the combined M and N target pattern comprising a combination of an M pole pair pattern and an N pole pair pattern, where M and N are positive integers and N>M.

30. The apparatus of claim 29, wherein the target pattern of the target body is at least partially based on a spatial area-wise logical AND of a first standard target design pattern and a second standard target design pattern, the first standard target design pattern for angular-position sensing using an M pole pair sensor, the second standard target design pattern for angular-position sensing using an N pole pair sensor.
